(19) United States
(12) Patent Application Publication
(10) Pub. No.: US 2025/0184777 A1
(43) Pub. Date: Jun. 5, 2025

(54) ESTIMATION OF NETWORK THROUGHPUT

(71) Applicant: QUALCOMM Incorporated, San Diego, CA (US)

(72) Inventors: Yubing JIAN, San Diego, CA (US); Leena ZACHARIAS, San Jose, CA (US); Arnaud MEYLAN, San Diego, CA (US); Diwakar Sai PANCHAMGAM, Hyderabad (IN); Neel Vikramkumar SHAH, San Diego, CA (US)

(21) Appl. No.: 18/842,006

(22) PCT Filed: Apr. 20, 2023
(86) PCT No.: PCT/US2023/019310

§ 371 Date: Aug. 27, 2024

(30) Foreign Application Priority Data
Apr. 22, 2022 (IN) 202241023726

(51) Int. Cl. H04W 24/08; H04W 72/12; H04W 72/1268; H04W 72/542

(52) U.S. Cl. CPC H04W 24/08; H04W 72/1221; H04W 72/1268; H04W 72/542

(57) ABSTRACT

A UE may be configured with an enhanced network throughput for data transmission with a small burst or a low burst. In one aspect, for the network throughput estimation for an UL transmission with a small burst, the UE may calculate the burst duration by excluding the SR lead time from the burst period. In another aspect, for the network throughput estimation for a window with the low burst duration, the UE may calculate a scaling factor between the channel bit rate and the estimated network throughput of a time window with a sufficient burst duration and estimate the network throughput of the low burst duration based on the estimated channel bit rate and the scaling factor. In another aspect, to improve the overall process of the network throughput estimation, the UE may dynamically adjust the associated parameters by comparing the estimated network throughput with a base throughput.

### CROSS-REFERENCE TO RELATED APPLICATION

This application claims the benefit of Indian Patent Application number 202241023726, entitled “ESTIMATION OF NETWORK THROUGHPUT” and filed on Apr. 22, 2022, which is expressly incorporated by reference herein in its entirety.

### TECHNICAL FIELD

The present disclosure relates generally to communication systems, and more particularly, to a method of wireless communication including an estimation of network throughput at a user equipment (UE).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may include a user equipment (UE) configured to determine a scheduling request (SR) lead time within an uplink (UL) burst period, determine a burst duration based on the UL burst period and the determined SR lead time, and estimate an UL throughput within a window including the UL burst period based on the determined burst duration.

In another aspect of the disclosure, a method, a computer-readable medium, and an apparatus are provided. The apparatus may include a UE configured to estimate a previous throughput, and estimate a current throughput in a window based on the previously estimated throughput, a previous estimated channel bit rate, and a current estimated channel bit rate. The previous estimated channel bit rate and the current estimated channel bit rate may be based on at least one of a reference signal received power (RSRP), a reference signal received quality (RSRQ), a signal to noise ratio (SNR), a signal to interference plus noise ratio (SINR), a path loss, multiple-input and multiple-output (MIMO) layers, a number of component carriers (CCs), a scheduling rate, a bandwidth, a traffic type, or a power headroom report. The current throughput may be estimated based on the previously estimated throughput, the previous estimated channel bit rate, and the current estimated channel bit rate based at least on a current burst duration within a current window being less than or equal to a threshold percentage of a window length of the window and the current window. The current throughput may be estimated to be R2=R1*c2/c1, where R2 is the estimated current throughput, R1 is the previously estimated throughput, c2 is the current estimated channel bit rate, and c1 is the previous estimated channel bit rate, and where the current window is associated with the estimated current throughput, and the window is a previous window associated with the previously estimated throughput, the previous window having a burst duration that exceeds a burst duration threshold.

In another aspect of the disclosure, a method, a computer-readable medium, and an apparatus are provided. The apparatus may include a UE may optimize configurable variables for estimating the current throughput based on a difference between the current throughput and a base throughput, and estimate a current throughput in a window based on the previously estimated throughput, a previous estimated channel bit rate, and a current estimated channel bit rate. The configurable variables may include at least one of a window length of the window, a window stepsize for adjusting the window when estimating additional throughputs, a linear coefficient for estimating the throughput, a filter coefficient for estimating the throughput based on a previously estimated throughput, or a burst duration threshold associated with the window.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and UE in an access network.

FIG. 4 is a diagram showing the network throughput estimation of a method of wireless communication.

FIG. 5 is a call-flow diagram of a method of wireless communication.

FIG. 6 illustrates an UL throughput estimation in UL burst transmissions of a method of wireless communication.

FIG. 7 is a diagram of an example of the network throughput estimation of wireless communication.

FIG. 8 is a diagram of an example of dynamic parameter adjustment of a method of wireless communication.

FIG. 9 is a call-flow diagram of a method of wireless communication.

FIG. 10 is a flowchart of a method of wireless communication.

FIG. 11 is a flowchart of a method of wireless communication.

FIG. 12 is a flowchart of a method of wireless communication.

FIG. 13 is a flowchart of a method of wireless communication.

FIG. 14 is a diagram illustrating an example of a hardware implementation.

### DETAILED DESCRIPTION

In case of data transmission with a small burst window or a low burst duration window, a network throughput may be underestimated or overestimated. The user equipment (UE) may reduce error in the network throughput estimation by calculating the burst duration for the small burst, using a scaling factor to estimate the network throughput of the low burst duration, or dynamically adjusting the associated parameters used for estimating the network throughput.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

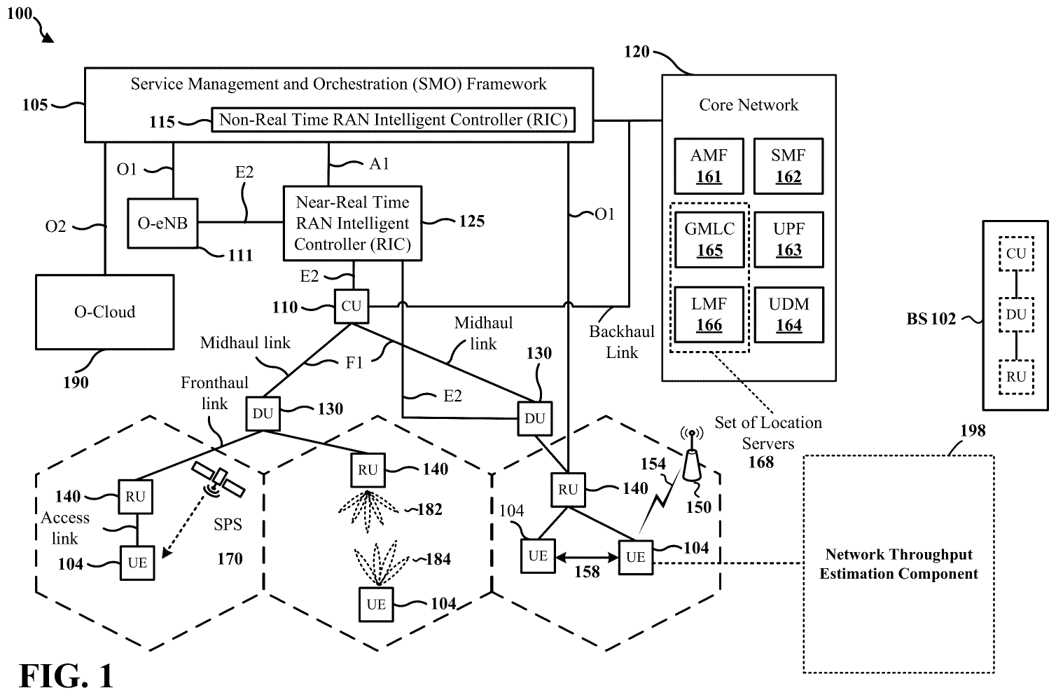

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-62.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 62.6 GHz. For example, three higher operating bands have been identified as frequency range designations FR2-2 (52.6 GHz-71 GHZ), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a network throughput estimation component 198 configured to determine a SR lead time within an UL burst period, determine a burst duration based on the UL burst period and the determined SR lead time, and estimate an UL throughput within a window including the UL burst period based on the determined burst duration. The network throughput estimation component 198 is also configured to estimate a previous throughput, and estimate a current throughput in a window based on the previously estimated throughput, a previous estimated channel bit rate, and a current estimated channel bit rate. The network throughput estimation component 198 is also configured to optimize configurable variables for estimating the current throughput based on a difference between the current throughput and a base throughput, and estimate a current throughput in a window based on the previously estimated throughput, a previous estimated channel bit rate, and a current estimated channel bit rate. Although the following description may be focused on 5G NR, the concepts described herein may be applicable to other similar areas, such as LTE, LTE-A, CDMA, GSM, and other wireless technologies.

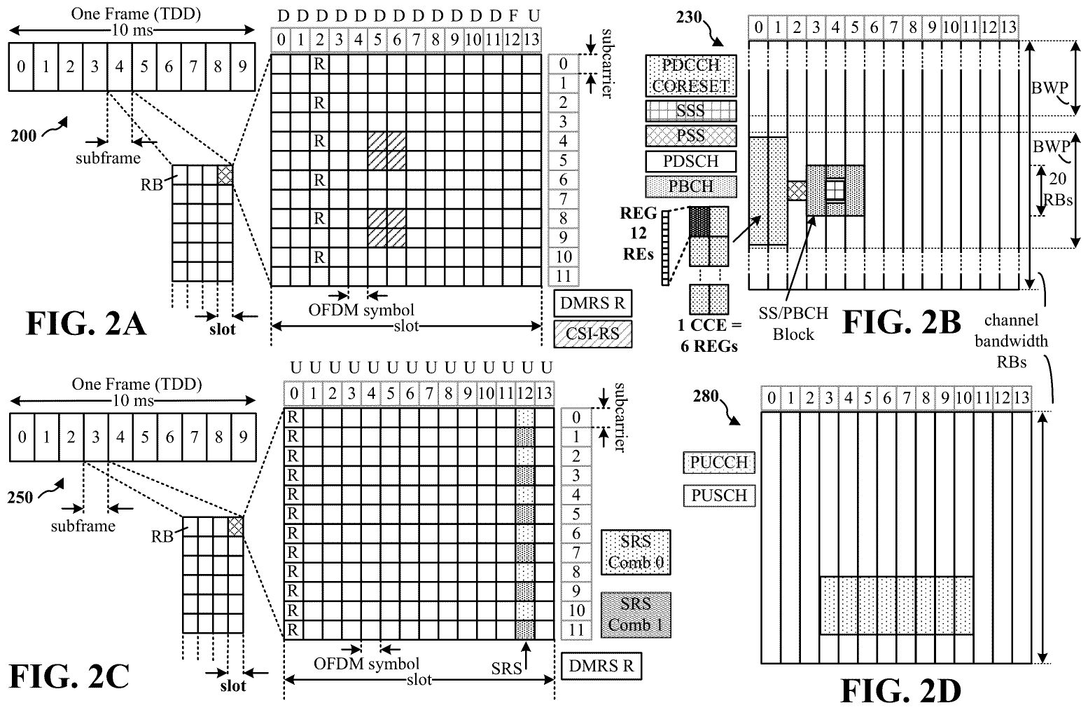

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 24*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical UL shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

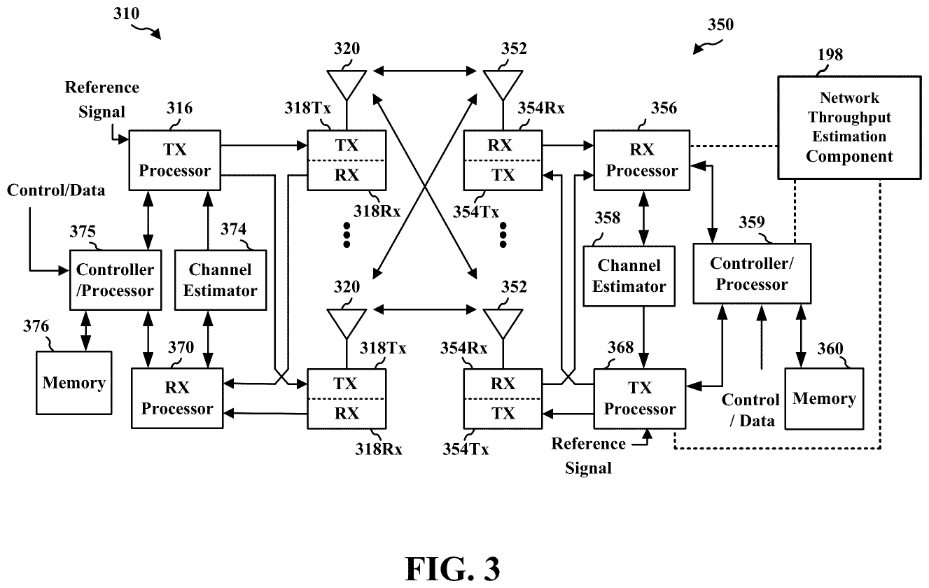

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization. The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the network throughput estimation component 198 of FIG. 1.

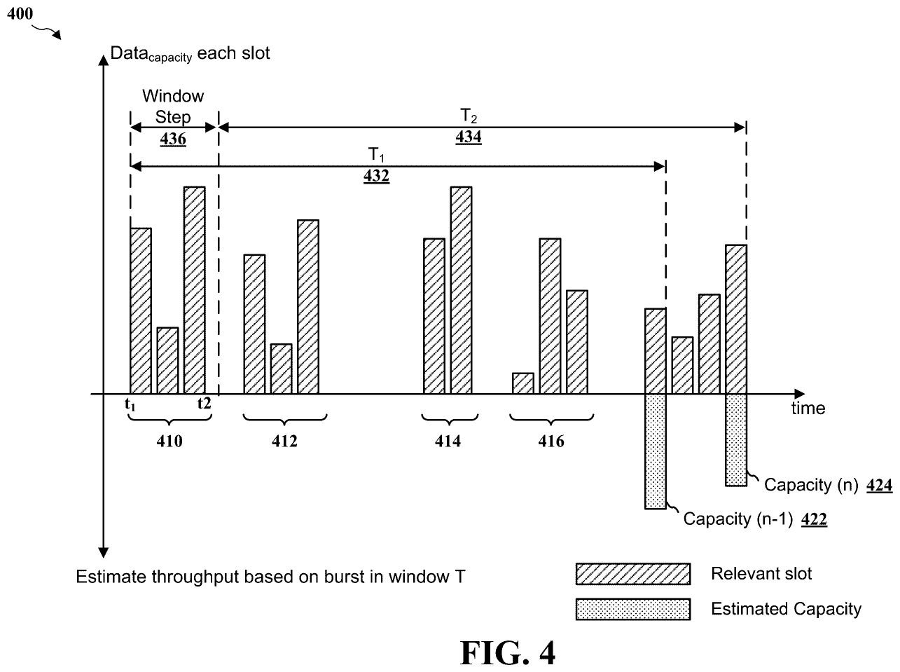

FIG. 4 is a diagram 400 showing the network throughput estimation of a method of wireless communication. A wireless network may include a UE and a network node. The network node may be a part of the wireless network, and the wireless network may include a scheduler. As part of wireless network access, the scheduler of the serving network node may schedule DL resources for DL transmissions. When the UE has data for UL transmissions, the UE may transmit a, SR, and the scheduler may grant the UE uplink resources for UL transmissions. The DL resources scheduled and the UL resources granted for the UE for DL/UL transmissions may depend on various factors, for example, channel characteristics or the number of UEs being served by the serving network node.

In some aspects, the UE may estimate proper throughput of the network, and applications of the UE may be configured to adjust their operations in accordance with the estimated throughput of the network. That is, the UE may estimate the UL/DL throughput, and adjust the operation according to the estimated UL/DL throughput. For example, if an application is configured to transmit video data and transmitting the video data under the estimated UL throughput may cause latency, the application may delay the transmission until the UL throughput is estimated greater than a threshold value or resize the video data using a lower bit rate or resolution. The applications may adjust its operation in advance based on the estimated UL/DL throughput estimated in advance.

In one aspect, the UE may include the network throughput estimator (e.g., the network throughput estimation component 198) for predicting or estimating available UL/DL throughput for future DL/UL communications by estimating the network throughput. Here, the network throughput may be based on the maximum capacity calculated within a time window. The network throughput estimation may be referred to as a rate estimation, and it may be provided for applications to understand the future cellular network capacity. With knowledge of the network capacity (e.g., estimated available UL/DL throughput), the applications may optimize their corresponding behaviors to improve the user experience for end-users. That is, based on the UL/DL throughput estimation, the processor and/or application may adjust its operation and transmit the UL data to the serving network node and receive the DL data from the serving network node. For example, a video application of the UE may auto-tune its video resolution based on the network capacity.

The network throughput estimator (e.g., the network throughput estimation component 198) of the UE may estimate the achievable DL/UL throughput (or maximum network throughput) based on current network and traffic conditions. To estimate or compute the network throughput, the UE may compute the throughput of each burst of data, and the estimate may not be impacted by the duration without data transmissions.

Referring to FIG. 4, the UE may estimate the network capacity at a given time. The diagram 400 shows that the data capacity of each slot is transmitted in bursts, including a first burst 410, a second burst 412, a third burst 414, and a fourth burst 416. Each burst of data transmissions (e.g., UL transmissions or DL transmissions) may include corresponding an SR, a burst period, and a burst duration, the burst duration referring to the time duration or period from the start of the burst to the end of the burst. For example, the diagram 400 shows that the first burst 410 may have a first burst duration of t₂−t₁.

The UE may estimate the network throughput at a given time. The network capacity may be estimated based on the data capacities transmitted during a time window T. The time window T may be a sliding window, shifting by a multiple of a unit window step 436 in time. Here, the capacity (n−1) 422 may represent the network capacity at a time (n−1), and the capacity n 424 may represent the network capacity at a time n. The capacity (n−1) 422 may be determined based on the data capacities transmitted during a first time window T₁ 432, and the capacity (n) 424 may be determined based on the data capacities transmitted during a second time window T₂ 434, where the second time window T₂ 434 is offset from the first time window T₁ 432 at the window step 436.

In one aspect, the network capacity may be estimated depending on a burst throughput (capacityₘₐₓ) and a mean throughput (capacityₘᵢₙ). The burst throughput may represent the maximum network capacity, and in one example, the maximum network capacity may be calculated as sum of data_{capacity} in each sliding window over the total burst duration of the window. The mean throughput may represent the minimum network capacity, and in one example, the minimum network capacity may be calculated as sum of data_{capacity} in each sliding window over the window. Based on the capacityₘₐₓ and the capacityₘᵢₙ, the network throughput estimator may determine a filtered throughput represented as capacity(n)=(1−μ)·capacityₘᵢₙ+μ·capacityₘₐₓ, where μ may be referred to as a linear coefficient. The UE may estimate the throughput of the network as R_{estf}(n)=min((1−α). R_{estf}(n−1)+α·capacity(n), configured throughput), where a may be referred to as a filter coefficient. The network throughput estimator may report the estimated network throughput R_{estf}(n) to the application, and the application may adjust its operation associated with the UL/DL data transmission based on the reported estimated network throughput R_{estf}(n).

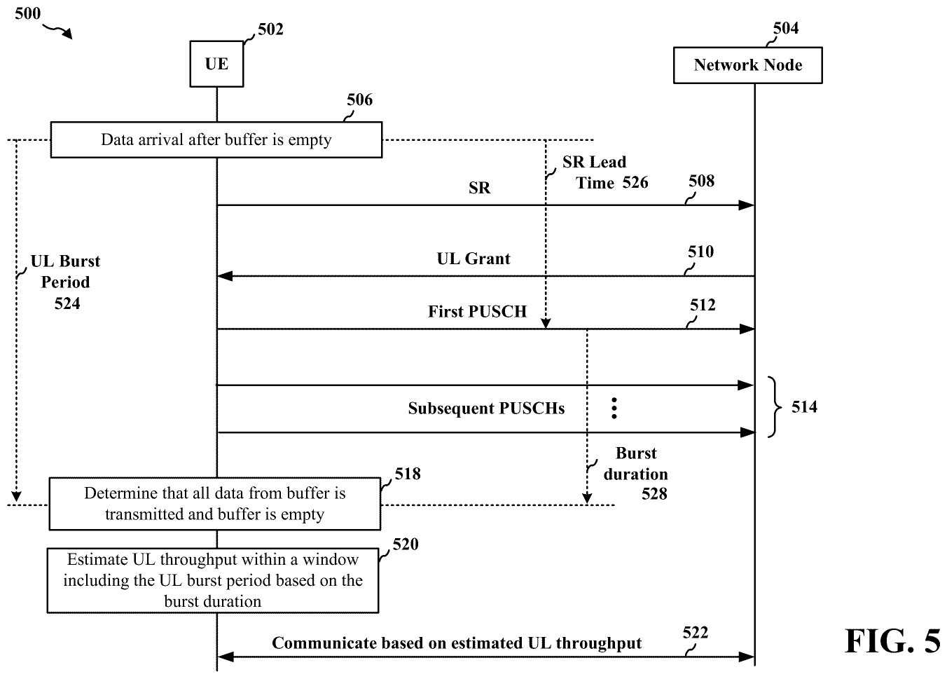

Referring to FIG. 5, in some aspects, to improve the accuracy of a network throughput estimation (e.g., the estimation of the UL throughput) at 520, the UE 502 may calculate a burst duration by excluding the time period that is not associated with the UL transmissions from the UL burst period. That is, the UE 502 may calculate a burst duration 528 as the modified burst duration by excluding a SR lead time 526 from the UL burst period 524 and use the burst duration 528. Here, the SR lead time 526 may refer to a time period between when the data is first available in the buffer at the UE 502 for the UL transmission where previously there is no data in the buffer at 506, and transmission of the first PUSCH at 512.

In one example, the applications may assume the current estimated network throughput as the future network throughput. However, the network throughput may change with regard to time, and to use the current estimated throughput as the reference for the future rate, the accuracy of the network throughput estimation may be enhanced to improve the estimation of the future network throughput. Unless the throughput estimation has a relatively higher accuracy (e.g., above a certain level), the network throughput estimation may not be useful for application to optimize its future behavior.

In some aspects, data traffic transmission may be configured with data bursts which include fluctuations in the data traffic communicated, and the limited traffic may result in underestimation or overestimation of the network throughput. That is, burst data transmissions may include one part with bursts of data transmissions and another part with limited traffic, and to properly accommodate for the data transmission bursts, the network throughput estimator may be configured to estimate the network throughput to be close to the maximum rate for a given application traffic type, regardless of the limited traffic part.

The rate estimation may have reduced accuracy in cases of a small burst of traffic or a low burst duration. The small burst may refer to a burst including a small number of data transmissions. For example, the third burst 414 may be a smaller burst than the fourth burst 416. The low burst duration may refer to a percentage of a sum of the burst durations of the bursts within the window (or burst duration percentage) being lower than a threshold value. That is, the burst duration percentage of the the first to fourth bursts 410, 412, 414, and 416 may be X % of the first window T₁ and the threshold value may be Y %, and the burst transmissions within the first window T₁ may be a low burst duration if X is smaller than Y. For example, the burst duration percentage of the first to fourth bursts 410, 412, 414, and 416 may be 45% of the first window T₁ and the threshold value may be 10%, 15% or 20%, and the UE may determine that the burst transmissions within the first window T₁ may not be a low burst duration. Accordingly, the accuracy of the network capacity estimation may be affected by data burst transmissions with relatively higher delay time in the small burst window or low burst durations in the low burst duration window. Furthermore, based on the static characteristics of the parameters used to estimate the network throughput, the estimated network throughput may consistently show an error between the estimated network throughput and the maximum rate for a given application traffic type.

In some aspects, a limited amount of traffic may cause the rate estimation algorithm to underestimate or overestimate the maximum rate for a given application traffic type. That is, the rate estimation applied to data transmissions with a limited amount of traffic may not provide an accurate estimation of the maximum rate for a given application traffic type. In one aspect, based on L2 event time of an UL communication, the UL traffic may include SR lead time during which the UL transmission burst is not communicated. To increase the accuracy of the rate estimation, the SR lead time may be removed from the burst duration calculation for uplink traffic. In another aspect, in the case of low burst duration, the estimation of the current modem rate may be determined based on the history of past modem rate, past and current channel condition fluctuation, e.g., signal to noise and interferences rate (SINR), and past and current UE configuration changes, e.g., layer change.

In some aspects, using a fixed set of parameters for estimation may result in limited rate estimation accuracy. That is, using a fixed set of parameters may produce persistent error in the network throughput estimation. Based on an error analysis between the estimated throughput and a base throughput (e.g., full buffer throughput), the UE may dynamically tune the parameters for the network throughput estimation, e.g., filter coefficient, to minimize or reduce the error.

FIG. 5 is a call-flow diagram 500 of a method of wireless communication. The call-flow diagram 500 may include a UE 502 and a network node 504. The UE 502 may include a buffer (e.g., PDCP buffer or RLC buffer) for UL transmission, and the buffer may be emptied after a complete and successful transmission of the data for UL transmission. At 506, current data for UL transmission may be available for the UE 502. That is, the current data for UL transmission may arrive at the buffer.

To initiate UL transmissions that arrived at the buffer at 506, the UE 502 may transmit an SR 508 to the network node 504. The network node 504 may include a scheduler, and based on the SR 508 received from the UE 502, the scheduler of the network node 504 may schedule the UL resources for the UE 502 to transmit the data in the UL transmission, e.g., PUSCHs. The network node 504 may transmit an UL grant 510 to the UE 502. The UL grant 510 indicates the scheduled UL transmissions for the UE 502. Based on the UL grant 510 received from the network node 504, the UE 502 may transmit a plurality of PUSCHs including the first PUSCH 512 and subsequent PUSCHs 514.

At 518, the UE 502 may determine that all data from the buffer is transmitted and the buffer is empty. That is, after successfully transmitting the data arrived at the buffer at 506 to the network node 504 via the plurality of PUSCHs including the first PUSCH 512 and the subsequent PUSCHs 514, the buffer may be empty.

At 520, the UE 502 may estimate the UL throughput (e.g., maximum UL throughput) within a window including the plurality of PUSCHs including the first PUSCH 512 and the subsequent PUSCHs 514. The estimation of the UL throughput may be based on an observed bit rate in the PUSCHs 512 and 514 during a burst duration 528 within the UL burst period 524. Here, the UL burst period may refer to a time period between 506, when the data is first available in the buffer at the UE 502 for the UL transmission where previously there is no data in the buffer, and 518, when the data is completely transmitted from the buffer resulting in no data in the buffer. Referring to the observed bit rate of the UL transmissions based on the plurality of PUSCHs including the first PUSCH 512 and the subsequent PUSCHs 514 transmitted during the UL burst duration 528, the UE may estimate an UL throughput for future UL transmissions. At 522, the UE 502 may communicate with the network node 504 based on the estimated UL throughput.

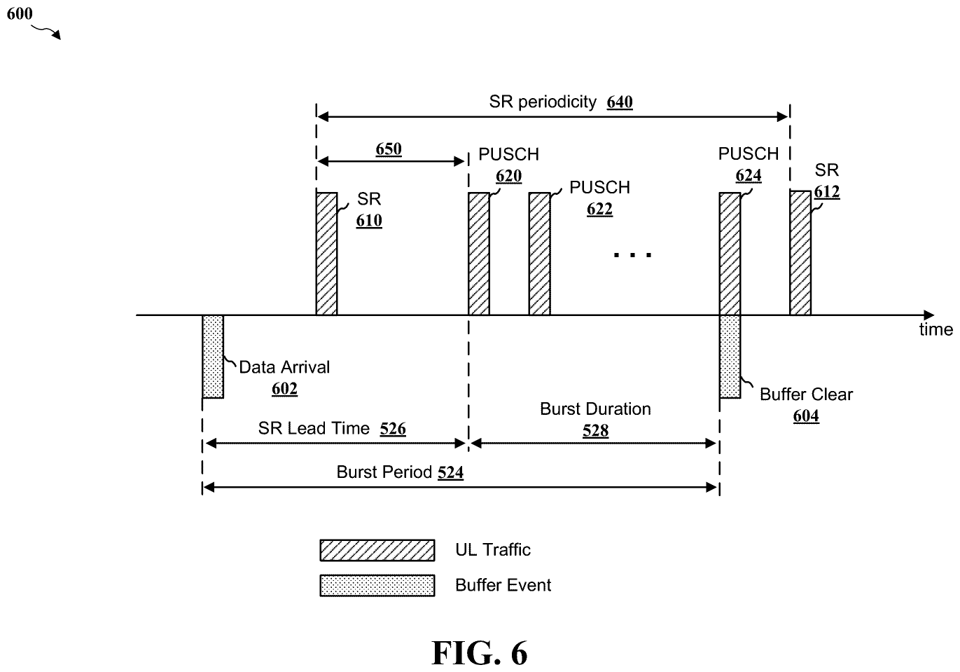

FIG. 6 illustrates an UL throughput estimation including UL burst transmissions 600 of a method of wireless communication. The UL burst transmissions 600 may include UL traffic, e.g., SRs 610 and 612 and a plurality of PUSCHs 620, 622, and 624, and a plurality of buffer events associated with the UL traffic including a data arrival 602 and a buffer clear 604. Here, the data arrival 602 may refer to a time when an empty PDCP buffer or RLC buffer may be filled with data for UL transmission. Based on the data arrival 602, the UE may transmit the SR to the network node. The SR may be transmitted to the network node to request that UL-SCH resources are scheduled for new UL transmissions. The UE may transmit a buffer status report (BSR) to provide the serving network node with information about the UL data volume in the MAC entity. In one aspect, the first PUSCH 620 triggered by the SR may be referred to as the SR PUSCH 620, and the SR PUSCH may contain the BSR. Using the plurality of PUSCHs 620, 622, and 624, the UE may transmit all the data arrived at the data arrival 602. After fully transmitting the data from the buffer memory, the buffer memory may be cleared out at the buffer clear 604. That is, at the buffer clear 604, the buffer clear may happen when all the PDCP/RLC buffer is empty from the complete transmission of the data received at the data arrival 602.

Here, the maximum network capacity may be calculated based on a total data_{capacity} (or an observed bit rate) and the burst duration. In one aspect, the maximum network capacity may be calculated as the total data capacity (or the observed bit rate) over the burst duration. That is, the maximum network capacity may be calculated as

$${capacity}_{max} = \frac{\sum {data}_{capacity} in burst duration}{burst duration} .$$

For example, the total data_{capacity} may be 10184 bytes, the UL burst period 524 may be 24 ms, and the number of PUSCH bursts may be 8. Accordingly, the maximum network capacity may be calculated as

$${capacity}_{max} = \frac{10184 \cdot 8}{0.024} \cdot {10}^{- 6} = 3.3 \; 95 Mbps .$$

An SR lead time 526 may refer to the duration from the data arrival 602 in the buffer to the time of the first PUSCH 620. The SR 610 and 612 may have an SR periodicity 640, which refers to the periodicity to transmit each SR 610 and 612 configured by the RRC for the default internet bearer. A network scheduling delay 650 may refer to a time from the SR 610 to the SR PUSCH 620.

In some aspects, an estimation of a small burst of UL traffic may result in an underestimation or an overestimation of the network throughput. That is, the estimation of the network throughput based on data transmission with a relatively smaller amount of traffic may not provide an accurate estimation of the maximum rate for a given application traffic type.

The UL burst period 524 includes the SR lead time 526, and the SR lead time 526 is the duration for UE to request the UL grant to transmit the UL traffic. Because each UL burst period 524 includes the SR lead time 526 that does not include the transmission of the PUSCH bursts, the estimation of the network throughput using the UL burst period 524 may be affected by the SR lead time 526. The SR lead time 526 may be comparably longer for a small burst of traffic on the UL, e.g., a single slot of traffic, and may lead to underestimation or overestimation issues. That is, the SR lead time 526 may not be significantly different for a large burst of traffic and a small burst of traffic, and the SR lead time 526 may have a relatively greater effect on the underestimation or the overestimation of the network throughput estimation on the small burst of traffic than the large burst of traffic. In one aspect, to reduce the underestimation or the overestimation of the network throughput, the SR lead time 526 may be dynamically or statically removed from the burst period 524, and the modified burst duration may be used to estimate the UL throughput.

In one aspect, the UE may dynamically determine the part of the burst duration that was spent in waiting for the first PUSCH and remove the corresponding waiting time, e.g., the SR lead time 526, which may be bounded by the TDD cycle. That is, the burst duration 528 may be dynamically calculated by excluding the SR lead time 526 from the burst period 524, while limited by the configured number of slots per each UL slot. Here, the number of slots per each UL slot may refer to an average number of slots that includes one UL slot. For example, when the slot format may include one UL slot per 5 slots, e.g., DDDSU, then the number of slots per each UL slot may be 5. Because the earliest possible transmission of the SR PUSCH 620 after the SR 610 may be 5 slots, dynamic burst duration may be bound by the number of slots per each UL slot, e.g., 5 slots. Accordingly, the dynamic burst duration may be calculated as a maximum of (A) the UL burst period 524 excluding the SR lead time 526, and (B) the number of slots per each UL slot associated with the TDD cycle time period, i.e., dynamic burst duration=max ((Burst duration−SR lead time), num of slots per each UL slot).

For example, the total data_{capacity} may be 10184 bytes, the UL burst period 524 may be 24 ms, the number of PUSCH bursts may be 8, and the SR lead time 526 may be 12 ms, and the number of slots per each UL slot may be 5. Accordingly, the dynamic burst duration may be max (24-12, 5)=12 ms, and the modified maximum network capacity may be calculated as new

$${capacity}_{max} = \frac{10184 \cdot 8}{0.012} \cdot {10}^{- 6} = 6.8 Mbps .$$

The modified estimation of the rate based on the dynamic burst duration may be doubled when compared to the calculation of the rate based on the burst period 524.

In another aspect, the UE may statically calculate the modified burst duration based on an average SR lead time. The average SR lead time may be statically calculated based on an average time period that the UE waits to send the SR that depends on an SR periodicity and an average delay for the UE to transmit a first PUSCH as a result of an UL grant that the UE receives after sending the SR. In one example, the average SR lead time may be a sum of delay caused by half of SR periodicity and network scheduling delay. That is, the average SR lead time may be calculated as average SR

$$lead time ( n ) = \frac{SR periodicity}{2} + average SR delay ( n ) .$$

Based on the average SR lead time, the UE may statically determine the modified burst duration as a maximum of (A) the UL burst period 524 excluding the average SR lead time (n), and (B) the number of slots per each UL slot associated with the TDD cycle time period. That is, the modified static burst duration may be calculated as max((burst duration−average SR lead time), slot num per ul slot).

For example, the total data_{capacity} may be 10184 bytes, the UL burst period 524 may be 24 ms, the number of PUSCH bursts may be 8, the SR periodicity may be 20 ms, and the number of slots per each UL slot may be 5. The SR periodicity may be configured by RRC for a default internet bearer. Accordingly, the static burst duration may be max (24−10−2, 5)=12 ms, and the modified maximum network capacity may be calculated as new

$${capacity}_{max} = \frac{10184 \cdot 8}{0.012} \cdot {10}^{- 6} = 6.8 Mbps .$$

The modified estimation of the rate based on the static burst duration may be doubled when compared to the calculation of the rate based on the UL burst period 524.

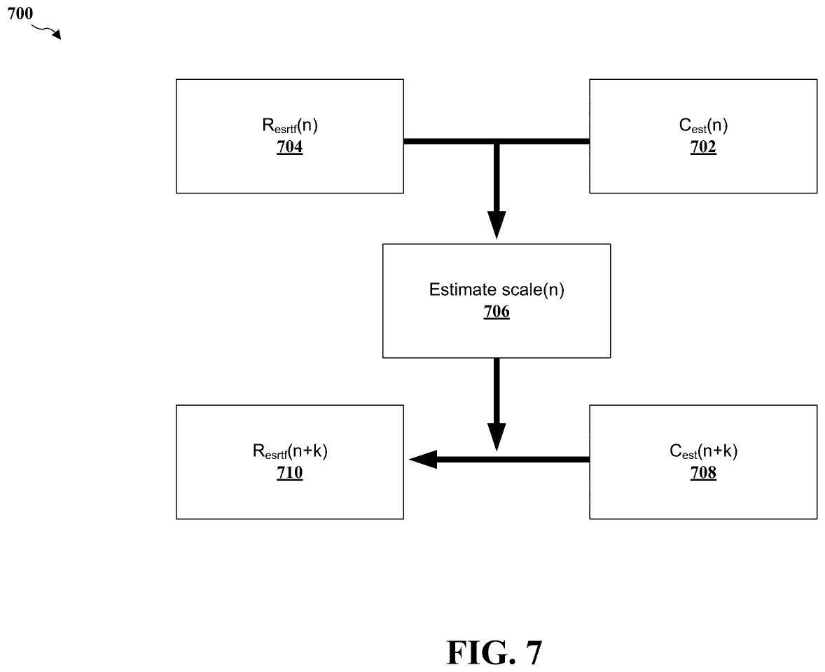

FIG. 7 is a diagram 700 of an example of network throughput estimation of wireless communication. The diagram 700 may include estimated channel bit rate Cₑₛₜ (n) 702 of the n^{th} window, estimated network throughput R_{estf} (n) 704 of the n^{th} window estimated based on applying the network throughput estimation algorithm to the Cₑₛₜ (n) 702, estimated channel bit rate Cₑₛₜ (n+k) 708 of the (n+k)^{th} window, and estimated network throughput R_{estf} (n+k) 710 of the (n+k)^{th} window estimated based on the Cₑₛₜ (n+k) 710. Here, k may refer to an index number different between the n^{th} window and the (n+k)^{th} window. In one example, the n^{th} window may have a sufficient burst duration with the sufficient burst duration percentage. Here, the sufficient burst duration percentage may refer to the burst duration percentage greater than a threshold value. The estimated channel bit rate of the n^{th} window Cₑₛₜ (n) 702 and the estimated network throughput of the n^{th} window R_{estf} (n) 704 may correspond with either the UL or DL communications, and the n^{th} window may be associated with the network throughput estimation of the UL traffic or the DL traffic. The estimated channel bit rate of the (n+k)^{th} window Cₑₛₜ (n+k) 708 and the estimated network throughput of the (n+k)^{th} window R_{estf} (n+k) 720 may correspond with either the UL or DL communications, and the (n+k)^{th} window may be associated with the throughput estimation of the UL traffic or the DL traffic. The Cₑₛₜ (n) 702 may include or be associated with an estimated channel bit rate of the window n, an estimated UL/DL capacity (e.g., Shannon) of the window n, or an estimated UL/DL spectral efficiency of the window n.

The network throughput estimation may have a reduced error when the estimation is based on a sufficient burst duration, and the sufficient burst duration may depend on the transmission grant quality, such as burst duration, TB size, etc. On the other hand, the network throughput estimation in low burst duration windows may be underestimated or overestimated.

In the low burst duration windows, the UE may reduce the error by using a scaling factor between the calculated channel bit rate and the estimated network throughput at a time window with a sufficient burst duration percentage (e.g., max throughput). Assuming that the scaling factor may represent the offset the between the channel bit rate and the network throughput associated with the current UE/network configurations (e.g., RBs, CC, layers, etc. The UE may use the updated channel condition, UE/network configurations), the UE may use a history of the scaling factor to estimate the network throughput based on the low burst duration windows. That is, to compensate for the underestimation or the overestimation of the network throughput in the low burst duration windows, the UE may calculate the scaling factor between the channel bit rate and the estimated network throughput of a time window from the history with a sufficient burst duration and apply the scaling factor to the estimated channel bit rate to calculate the estimate network throughput.

The (n+k)^{th} window may be a low burst duration window with a low burst duration traffic. In some aspects, the network throughput estimator may estimate the network throughput at (n+k)^{th} window with low burst duration traffic, e.g., a ping traffic. Ideally, regardless of the current traffic pattern, the estimated network throughput may be configured to approach the maximum rate supported by the modem (i.e., the network throughput that may be achieved in the full buffer traffic). However, because the (n+k)^{th} window may be a low burst duration window with a low burst duration traffic, the estimated network throughput of the (n+k)^{th} window may not reach the maximum rate supported by the modem.

The n^{th} window may include a sufficient burst duration, e.g., a window with a burst duration percentage greater than or equal to a threshold value, such as a full buffer, the UE may refer to the relation between the estimated channel rate Cₑₛₜ (n) 702 and the estimated network throughput R_{estf} (n) 704 to estimate the proper network throughput of the estimated network throughput R_{estf} (n+k) 710 based on the Cₑₛₜ (n+k) 708. That is, the network throughput estimator may generate a scale factor (n) 706 between the estimated channel bit rate Cₑₛₜ (n) 702 and the estimated network throughput R_{estf} (n) 704 of the n^{th} window configured with the sufficient burst duration and estimate the network throughput of the R_{estf} (n+k) 710 based on the estimated channel bit rate Cₑₛₜ (n+k) 708 of the (n+k)^{th} window and the scale factor (n) 706.

In one aspect, the n^{th} window may be the window with a sufficient burst duration. The UE may be configured to estimate or collect channel conditions (n), which may refer to the channel status of the n^{th} window, e.g., SINR (n), and UE configurations (n), which may include the collected number of CCs (component carrier), layers, RB, scheduling pattern, etc.

The UE may determine the channel bit rate Cₑₛₜ (n) 702 of the n^{th} window by (A) calculating based on collected UE measurements (e.g., scheduled throughput which is greater than maximum network capacity), or (B) estimating using a function of layers, a number of the CCs, etc. For example, the channel bit rate Cₑₛₜ (n) may be estimated as a function of an RSRP, an RSRQ, an SNR, an SINR, a path loss, MIMO layers, the number of CCs, a scheduling rate, a bandwidth, a traffic type, or a PHR. The network throughput R_{estf} (n) 704 of the of the n^{th} window may be estimated based on the channel bit rate Cₑₛₜ (n) 702. Here, as discussed in FIGS. 5 and 6, the UE may determine the filtered throughput represented as capacity(n)=(1−μ)·capacityₘᵢₙ+μ·Cₑₛₜ (n), and the UE may estimate the R_{estf} (n) 704 as R_{estf}(n)=min((1−α)·R_{estf}(n−1)+α·capacity(n), configured throughput), based on the channel bit rate Cₑₛₜ (n) 702.

The network throughput estimator may be configured to estimate or calculate the scaling factor scale (n) 706 based on the network throughput estimation at the n^{th} window with a sufficient burst duration. That is, the scale (n) 706 of the n^{th} window may represent the ratio between the theoretical throughput (e.g., the network throughput estimated for a window have a sufficient burst duration) and the actual estimated channel bit rate based on the channel configurations (n), such as the number of CC, scheduling, etc. For example, the scale (n) 706 may be calculated as

$$scale ( n ) = \frac{{R}_{estf} ( n )}{{c}_{est} ( n )} .$$

The (n+k)^{th} window may be the window with a low burst duration. The UE may collect or estimate a channel condition (n+k) or UE configurations (n+k) to determine whether it changed from the channel conditions (n) or the UE configurations (n). The UE may estimate the channel bit rate Cₑₛₜ (n+k) 708 of the (n+k)^{th} window using a function of layers, a number of the CCs, etc. For example, the channel bit rate Cₑₛₜ (n+k) may be estimated as a function of an RSRP, an RSRQ, an SNR, an SINR, MIMO layers, number of CCs, a scheduling rate, a bandwidth, a traffic type, or a PHR. Here, the relevant factors, e.g., the number of the component carriers, the number of layers per component carriers, etc., may be updated for the (n+k)^{th} window for a better estimation based on the collected or estimated channel condition (n+k) or UE configurations (n+k).

The network throughput estimator may calculate the network throughput R_{estf} (n+k) 710 of the (n+k)^{th} window based on the scale (n) 706 and the estimated channel rate Cₑₛₜ (n+k) 708 of the (n+k)^{th} window. That is, the network throughput R_{estf} (n+k) 710 may be calculated as

$${R}_{estf} ( n + k ) = scale ( n ) \cdot {c}_{est} ( n + k ) = \frac{{R}_{estf} ( n )}{{c}_{est} ( n )} \cdot {c}_{est} ( n + k ) .$$

By using the ratio, e.g., the scale (n) 706, between the theoretical network throughput and the actual estimated throughput based on the channel configurations (n) of the n^{th} window with the sufficient burst duration, the network throughput estimator may estimate the network throughput R_{estf}(n+k) 710 of the (n+k)^{th} window to approach the maximum rate supported by the modem. Accordingly, the estimated network throughput R_{estf}(n+k) 710 of the (n+k)^{th} window with the low burst duration may have reduced error.

In some aspects, the result of the estimation may be analyzed by calculating an error based on a base throughput (or ground truth rate or a reference rate). The base throughput may refer to an estimated rate (or a network throughput) of a time window with a burst duration percentage greater than or equal to a threshold value, e.g., 80%. In one aspect, the UE may keep a record (or database) of the estimated rates of the time windows with burst duration percentages greater than or equal to the threshold value and the associated parameters, such as channel, UE, network configurations, and the UE may select the estimated rate from the record of the multiple estimated rate that matches the parameters of the current window as the base throughput for reference. The UE may assume that the base throughput represents the reference maximum network throughput associated with the parameters of the current window, and the UE may perform the error analysis to check if the network throughput estimation of the low burst duration is consistent with the base throughput estimation from the record.

For example, the record of the multiple estimated rates of the time windows with burst duration percentages greater than or equal to the threshold value and the associated parameters may be a circular buffer with a fixed number of entries, e.g., 1000 sets of record. The buffer may be rewritten from the first entry when the buffer is full. For example, the table below may show an example of the record of the multiple base throughputs and the associated parameters, where each row represents a set of entries. The traffic types may be associated with the types of application, e.g., full buffer, video streaming 360p, video streaming 720p, video call, ping with 10 ms periodicity, ping with 50 ms periodicity, etc.

| | | | | | | |
|---|---|---|---|---|---|---|
| Window | Burst duration | | | Traffic | | Estimated |
| Index | percentage | SINR | Layers | type | . . . | throughput |

| | | | | | |
|---|---|---|---|---|---|
| n | 90% | s1 | L1 | T1 | R1 |
| n + 1 | 92% | s2 | L2 | T2 | R2 |
| n + 2 | 98% | s3 | L3 | T3 | R3 |
| n + 4 | 99% | s4 | L4 | T4 | R4 |

The (n+k)^{th} window may be a low burst duration, e.g., the ping traffic. Here, the parameters of the (n+k)^{th} window, SINR, layer, traffic type, etc., may match the window (n+1), and therefore, the UE may select R2 as the base throughput for the reference of the (n+k)^{th} window. The UE may also determine the estimated throughput from the circular buffer that is associated with the set of parameters most closely matching the parameter of the (n+k)^{th} window as the base throughput. For example, the UE may apply a cosine similarity between window (n+k) and the recorded entries of the circular buffer to determine the base throughput. If the UE determines that no entry of the record has the cosine similarity higher than a threshold with the parameters of the (n+k)^{th} window, the UE may not perform the error analysis.

| | | | | | | |
|---|---|---|---|---|---|---|
| Window | Burst duration | | | Traffic | | Estimated |
| Index | percentage | SINR | Layers | type | . . . | throughput |

| | | | | | |
|---|---|---|---|---|---|
| n + k | 5% | s2 | L2 | T2 | Rk |

Based on the base throughput selected for the current window, e.g., the (n+k)^{th} window, the UE may analyze the error of the estimated rate. In one example, the error rate may be calculated as

$$Error = \frac{mean ( \vert {estimated}_{rate} - base throughput \vert )}{base throughput} .$$

Based on the calculated error, the UE may analyze whether the estimated rate of the current window is consistent with the base throughput estimation from the record.

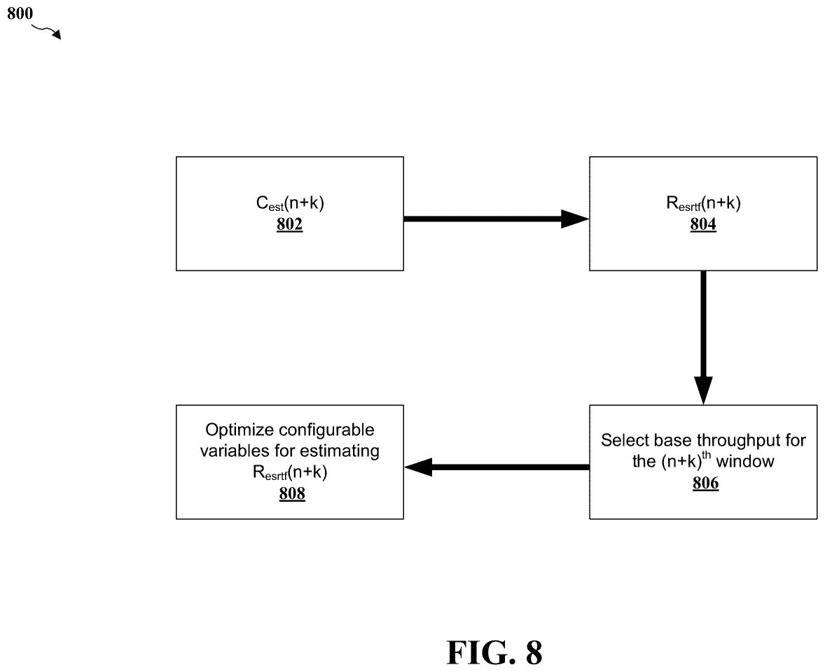

FIG. 8 is a diagram 800 of an example of dynamic parameter adjustment of a method of wireless communication. The diagram 800 illustrates that the UE may estimate the channel bit rate of the (n+k)^{th} window Cₑₛₜ (n+k) 802, and the UE may estimate the network throughput of the (n+k)^{th} window R_{estf} (n+k) 804. Here, the (n+k)^{th} window may be a low burst duration window with a low burst duration traffic, and the network throughput estimator may estimate the maximum rate for a given application traffic type at (n+k)^{th} window with low burst duration traffic, e.g., a ping traffic. Here, the Cₑₛₜ (n+k) 802 may include or be associated with an estimated channel bit rate of the window (n+k), an estimated UL/DL capacity (e.g., Shannon) of the window (n+k), or an estimated UL/DL spectral efficiency of the window (n+k).

In some aspects, multiple parameters may be used to estimate the channel bit rate Cₑₛₜ (n+k) at 802 and the network throughput R_{estf} (n+k) at 804 of the (n+k)^{th} window. For example, the multiple parameters may include the window time length and step or a ratio of window length and step, the linear coefficient of the capacity min and channel bit rate, the filter coefficient, and the low burst duration condition.

The UE may select the base throughput for the (n+k)^{th} window R_{estf} (n+k) 806. Because the (n+k)^{th} window may be a low burst duration window with a low burst duration traffic, the network throughput R_{estf} (n+k) 806 of the (n+k)^{th} window may have a relatively higher error rate based on the base throughput.

At 808, based on the estimated network throughput and base throughput, the UE may identify a set of configurable parameters that may minimize or reduce the error. That is, the UE may optimize the configurable parameters for estimating the network throughput R_{estf} (n+k) of the (n+k)^{th} window. In one aspect, the UE may apply different variables and perform the error analysis to identify the set of parameters that generates the smallest error based on the base throughput. The set of parameters may be referred to as optimal parameters. The UE may use the optimal parameters for the future estimation of the channel bit rate and network throughput for low burst duration windows.

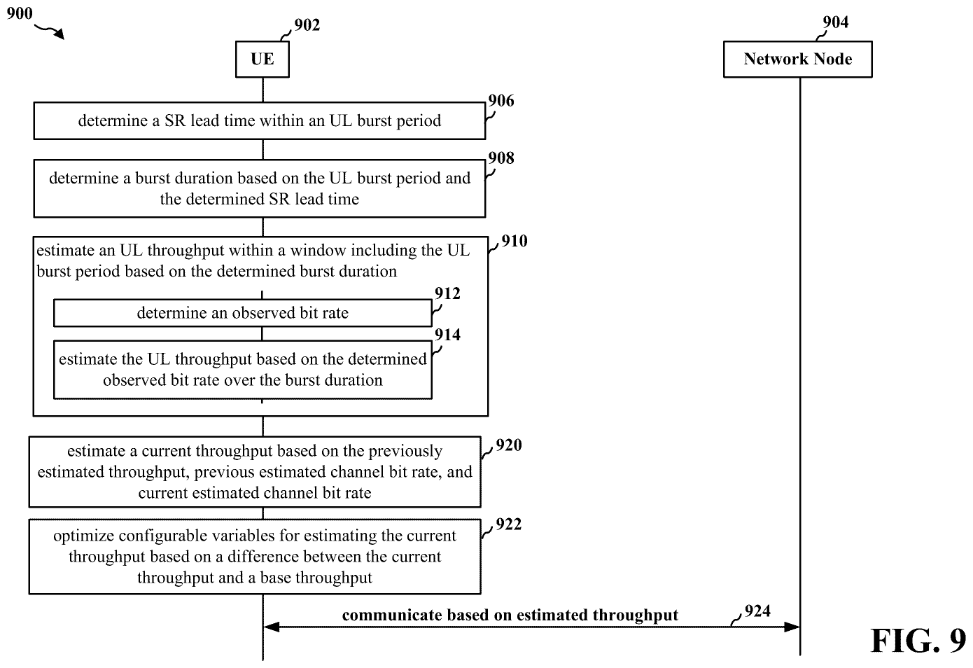

FIG. 9 is a call-flow diagram 900 of a method of wireless communication. The call-flow diagram 900 may include a UE 902 and a network node 904. The UE 902 may be configured to communicate with the network node 904 804 to receive wireless network access. The UE 902 may perform an enhanced network throughput for a small burst window or a low burst duration window. In one aspect, for the network throughput estimation for an UL transmission with a small burst, the UE 902 may calculate the burst duration by excluding the SR lead time from the burst period. In another aspect, for the network throughput estimation for a window with the low burst duration, the UE 902 may calculate a scaling factor between the channel bit rate and the estimated network throughput of a time window with a sufficient burst duration and estimate the network throughput of the low burst duration based on the estimated channel bit rate and the scaling factor. In another aspect, to improve the overall process of the network throughput estimation, the UE 902 may dynamically adjust the associated parameters by comparing the estimated network throughput with a base throughput.

In some aspects, the UE 902 may improve the accuracy of the network throughput estimation with the small burst by calculating the UL burst duration (e.g., burst duration 528) by excluding an SR lead time from the UL burst period (e.g., UL burst period 524).

At 906, the UE 902 may determine an SR lead time within an UL burst period (e.g., UL burst period 524). Here, the SR lead time (e.g., SR lead time 526/526) may be determined based on a time period between when data is first available in a buffer at the UE 902 for UL transmission where previously there is no data in the buffer before an SR is transmitted and when a first PUSCH based on an UL grant is transmitted subsequent to transmitting the SR and receiving the UL grant based on the transmitted SR, and the UL burst period may be a time period between when data is first available in a buffer at the UE 902 for UL transmission where previously there is no data in the buffer and when the data is completely transmitted from the buffer resulting in no data in the buffer. Because each UL burst period includes the SR lead time that does not include the transmission of the PUSCH bursts, the estimation of the network throughput using the UL burst period may be affected by the SR lead time, and the SR lead time may have relatively greater affect for the small burst window with shorter UL burst period. Accordingly, the UE 902 may determine the SR lead time and use the burst duration for network throughput estimation, where the burst duration is determined by excluding the SR lead time from the UL burst period.

The SR lead time may include dynamic SR lead time determined dynamically for each UL burst period, or static SR lead time statically estimated or calculated as an average SR lead time. In one aspect, the burst duration may be determined based on the UL burst period excluding the determined SR lead time. Here, the burst duration may be determined to be a maximum of (A) the UL burst period excluding the determined SR lead time, and (B) a number of slots per each UL slot. In another aspect, the determined SR lead time may be the average SR lead time, and the burst duration is determined based on the UL burst period excluding the determined average SR lead time. The burst duration may be determined to be a maximum of (A) the UL burst period excluding the determined average SR lead time, and (B) a number of slots per each UL slot, and the average SR lead time may be an average time period that the UE 902 waits to send that SR that depends on an SR periodicity and an average delay for the UE 902 to transmit a first PUSCH as a result of an UL grant that the UE 902 receives after sending the SR.

At 908, the UE 902 may determine a burst duration (e.g., burst duration 528; burst duration 528) based on the UL burst period and the determined SR lead time. That is, the UE 902 may determine the burst duration by excluding the SR lead time determined at 906 from the UL burst period. Here, the SR lead time may be the dynamic SR lead time or the static SR lead time.

At 910, the UE 902 may estimate an UL throughput within a window including the UL burst period based on the determined burst duration. By estimating the network throughput based on the burst duration and not the UL burst period, the UE 902 may reduce the effect of the SR lead time in the small burst window, and improve the accuracy of the network throughput estimation. 910 may include 912 and 914.

At 912, the UE 902 may determine an observed bit rate based on UL transmissions of the UE 902. Here, the observed bit rate based on UL transmission may be associated with a total data_{capacity}, and based on the observed bit rate, the UE 902 may estimate the maximum throughput as the observed bit rate over the burst period.

At 914, the UE 902 may estimate the UL throughput based on the determined observed bit rate over the burst duration. In one example, the UE 902 may determine a network capacity based on the maximum throughput, e.g., the network capacity(n)=(1−μ)·capacityₘᵢₙ+μ·capacityₘₐₓ at window n, and estimate the UL throughput as R_{estf}(n)=min((1−α)·R_{estf}(n−1)+α·capacity(n), configured throughput), where the capacityₘₐₓ is determined based on burst duration. Here, the u may be referred to as a linear coefficient, and the a may be referred to as a filter coefficient. Accordingly, the estimated UL throughput of the small burst window may have improved accuracy with reduced error.

In some aspects, the UE 902 may improve the accuracy of the network throughput estimation for a window with the low burst duration by calculating a scaling factor between the channel bit rate and the estimated network throughput of a time window with a sufficient burst duration and estimate the network throughput of the low burst duration based on the estimated channel bit rate and the scaling factor.

At 920, the determined burst duration may be a previous burst duration and the estimated throughput is a previously estimated throughput, and the UE 902 may estimate a current throughput based on the previously estimated throughput, previous estimated channel bit rate, and current estimated channel bit rate. Here, in the UL, the determined burst duration may be a previous burst duration and the estimated UL throughput is a previously estimated UL throughput, and the UE 902 may estimate a current UL throughput based on the previously estimated UL throughput, previous estimated UL channel bit rate, and current estimated UL channel bit rate.

In the low burst duration window, the network throughput estimation may be underestimated or overestimate, and therefore, the UE 902 may reduce the error by using a scaling factor between the calculated channel bit rate and the estimated network throughput at a time window with a sufficient burst duration percentage (e.g., max throughput). Assuming that the scaling factor may represent the offset the between the channel bit rate and the network throughput associated with the current UE 902/network configurations (e.g., RBs, CC, layers, etc. The UE 902 may use the updated channel condition, UE 902/network configurations), the UE 902 may use the scaling factor from the sufficient burst duration window to estimate the network throughput based on the low burst duration window.

The current UL throughput may be estimated based on the previously estimated UL throughput, the previous estimated UL channel bit rate, and a current estimated UL channel bit rate when both the current burst duration within the current window is less than or equal to the threshold percentage of the window length and a number of windows between the current window and the previous window is less than a threshold number of windows. Here, the current UL throughput may be associated with a current window (e.g., window (n+k)) which is a slow burst duration window, and the previously estimated UL throughput and the previously estimated UL channel bit rate are associated with a sufficient burst duration window (e.g., window n), and the index number different (e.g., k) may be less than a threshold number. Here, the previous estimated UL channel bit rate and current estimated UL channel bit rate may be one of an estimated UL capacity (e.g., Shannon) or an estimated UL spectral efficiency.

The current UL throughput may be estimated to be R2=R1*c2/c1, where R2 is the estimated current UL throughput, R1 is the previously estimated UL throughput, c2 is the current estimated UL channel bit rate, and c1 is the previous estimated UL channel bit rate, and wherein the current window is associated with the estimated current UL throughput, and the window is a previous window associated with the previously estimated UL throughput, the previous window having a burst duration that exceeds a burst duration threshold.

Here, the channel bit rate c1 of the previous window may be (A) calculated based on collected UE 902 measurements (e.g., scheduled throughput which is greater than maximum network capacity), or (B) estimated using a function of layers, a number of the component carriers (CCs), etc. For example, the channel bit rate c1 may be estimated as a function of an RSRP, an RSRQ, an SNR, an SINR, a path loss, MIMO layers, a number of CCs, a scheduling rate, a bandwidth, a traffic type, or a PHR. The channel bit rate c2 of the current window may be estimated using a function of layers, a number of the CCs, etc. For example, the channel bit rate c2 may be estimated as a function of an RSRP, an RSRQ, an SNR, an SINR, a path loss, MIMO layers, a number of CCs, a bandwidth, a traffic type, or a PHR.

In one aspect, for the UL transmission, the previous estimated UL channel bit rate and the current estimated UL channel bit rate may be based on at least one of an RSRP, an RSRQ, an SNR, an SINR, a path loss, MIMO layers, a number of CCs, a scheduling rate, a bandwidth, a traffic type, or a PHR. In another aspect, for the UL/DL transmission, the previous estimated channel bit rate and the current estimated channel bit rate may be based on at least one of an RSRP, an RSRQ, an SNR, an SINR, a path loss, MIMO layers, a number of CCs, a scheduling rate, a bandwidth, a traffic type, or a PHR.

The current UL throughput may be estimated based on the previously estimated UL throughput, the previous estimated UL channel bit rate, and the current estimated UL channel bit rate based at least on a current burst duration within a current window being less than or equal to a threshold percentage of a window length of the window and the current window.

In some aspects, the UE 902 may improve the accuracy of the network throughput estimation for a window with the low burst duration by dynamically adjusting the associated parameters by comparing the estimated network throughput with a base throughput.

At 922, the UE 902 may optimize configurable variables for estimating the current throughput based on a difference between the current throughput and a base throughput. Here, in the UL, the UE 902 may optimize configurable variables for estimating the current UL throughput based on a difference between the current UL throughput and a base UL throughput.

The base throughput may refer to an estimated rate (or a network throughput) of a time window with a burst duration percentage greater than or equal to a threshold value, e.g., 80%. In one aspect, the UE 902 may keep a record (or database, circular buffer, etc.) of the estimated rates of the time windows with burst duration percentages greater than or equal to the threshold value and the associated parameters, such as channel, UE, network configurations, and the UE 902 may select the estimated rate from the record of the multiple estimated rate that matches the parameters of the current window as the base throughput for reference. Then, the UE 902 may perform an error analysis of the current estimated throughput based on the selected base throughput as the reference value. The UE 902 may determine to perform the optimization if the result of the error analysis of the current estimated throughput is greater than or equal to a threshold value.

The configurable variables may include at least one of a window length of the window (e.g., T₁ 432 and T₂ 434), a window stepsize (e.g., window step 436) for adjusting the window when estimating additional UL throughputs, a linear coefficient (e.g., μ) for estimating the UL throughput, a filter coefficient (e.g., α) for estimating the UL throughput based on a previously estimated UL throughput, or a burst duration threshold associated with the window (e.g., burst duration percentage threshold value for determining the low burst duration window, the sufficient burst duration window, or the base throughput).

At 924, the UE 902 may communicate with a network entity in UL/DL based on the estimated throughput. Here, in the UL, the UE 902 may communicate with a network entity in UL based on the estimated UL throughput. Accordingly, the estimated throughput may not be underestimated or overestimated for the small burst window or a low burst duration window, and the application of the UE 902 may properly optimize its future behavior.

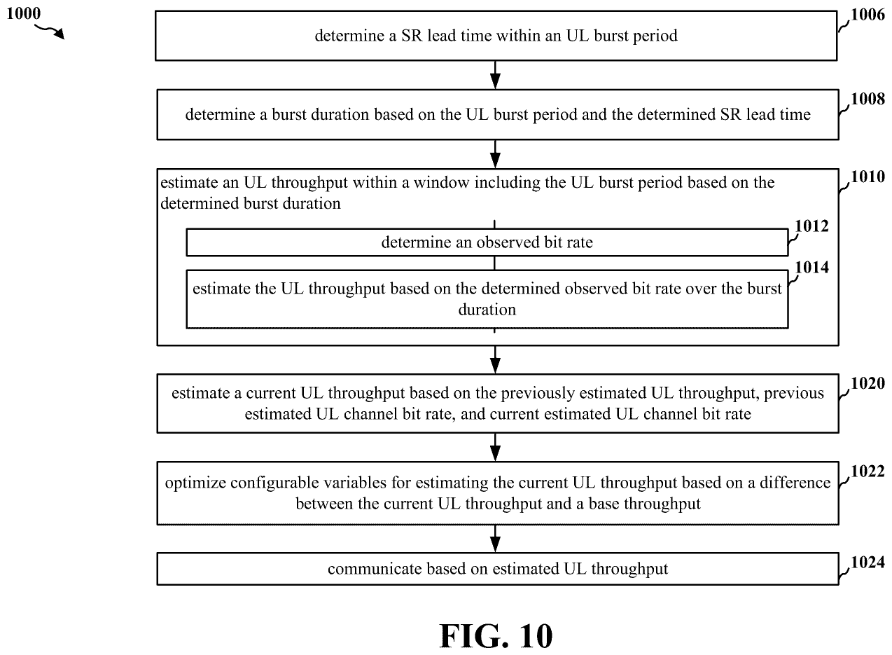

FIG. 10 is a flowchart 1000 of a method of wireless communication. The method may be performed by a UE (e.g., the UE 104; the apparatus 1404). The flowchart 1000 may include a UE and a network node. The UE may be configured to communicate with the network node 804 to receive wireless network access. The UE may perform an enhanced network throughput for a small burst window or a low burst duration window. In one aspect, for the network throughput estimation for an UL transmission with a small burst, the UE may calculate the burst duration 528 by excluding the SR lead time 526 from the burst period 524. In another aspect, for the network throughput estimation for a window with the low burst duration, the UE may calculate a scaling factor between the channel bit rate and the estimated network throughput of a time window with a sufficient burst duration and estimate the network throughput of the low burst duration based on the estimated channel bit rate and the scaling factor. In another aspect, to improve the overall process of the network throughput estimation, the UE may dynamically adjust the associated parameters by comparing the estimated network throughput with a base throughput.

In some aspects, the UE may improve the accuracy of the network throughput estimation with the small burst by calculating the UL burst duration (e.g., burst duration 528) by excluding an SR lead time 526 from the UL burst period (e.g., UL burst period 524).

At 1006, the UE may determine an SR lead time 526 within an UL burst period (e.g., UL burst period 524). Here, the SR lead time (e.g., SR lead time 526/526) may be determined based on a time period between when data is first available in a buffer at the UE for UL transmission where previously there is no data in the buffer before an SR is transmitted and when a first PUSCH based on an UL grant is transmitted subsequent to transmitting the SR and receiving the UL grant based on the transmitted SR, and the UL burst period 524 may be a time period between when data is first available in a buffer at the UE for UL transmission where previously there is no data in the buffer and when the data is completely transmitted from the buffer resulting in no data in the buffer. Because each UL burst period 524 includes the SR lead time 526 that does not include the transmission of the PUSCH bursts, the estimation of the network throughput using the UL burst period 524 may be affected by the SR lead time 526, and the SR lead time 526 may have relatively greater affect for the small burst window with shorter UL burst period. Accordingly, the UE may determine the SR lead time 526 and use the burst duration 528 for network throughput estimation, where the burst duration 528 is determined by excluding the SR lead time 526 from the UL burst period 524. The SR lead time 526 may include dynamic SR lead time determined dynamically for each UL burst period 524, or static SR lead time statically estimated or calculated as an average SR lead time. In one aspect, the burst duration 528 may be determined based on the UL burst period 524 excluding the determined SR lead time 526. Here, the burst duration 528 may be determined to be a maximum of (A) the UL burst period 524 excluding the determined SR lead time 526, and (B) a number of slots per each UL slot. In another aspect, the determined SR lead time 526 may be the average SR lead time, and the burst duration 528 is determined based on the UL burst period 524 excluding the determined average SR lead time. The burst duration 528 may be determined to be a maximum of (A) the UL burst period 524 excluding the determined average SR lead time, and (B) a number of slots per each UL slot, and the average SR lead time may be an average time period that the UE waits to send that SR that depends on an SR periodicity and an average delay for the UE to transmit a first PUSCH as a result of an UL grant that the UE receives after sending the SR. For example, at 906, the UE 902 may determine an SR lead time 526 within an UL burst period (e.g., UL burst period 524). Furthermore, 1006 may be performed by a network throughput estimation component 198.

At 1008, the UE may determine a burst duration (e.g., burst duration 528; burst duration 528) based on the UL burst period 524 and the determined SR lead time 526. That is, the UE may determine the burst duration 528 by excluding the SR lead time 526 determined at 1006 from the UL burst period 524. Here, the SR lead time 526 may be the dynamic SR lead time or the static SR lead time. For example, at 908, the UE 902 may determine a burst duration (e.g., burst duration 528; burst duration 528) based on the UL burst period 524 and the determined SR lead time 526. Furthermore, 1008 may be performed by the network throughput estimation component 198.

At 1010, the UE may estimate an UL throughput within a window including the UL burst period 524 based on the determined burst duration 528. By estimating the network throughput based on the burst duration 528 and not the UL burst period 524, the UE may reduce the effect of the SR lead time 526 in the small burst window, and improve the accuracy of the network throughput estimation. For example, at 910, the UE 902 may estimate an UL throughput within a window including the UL burst period 524 based on the determined burst duration 528. Furthermore, 1010 may be performed by the network throughput estimation component 198. 1010 may include 1012 and 1014.

At 1012, the UE may determine an observed bit rate based on UL transmissions of the UE. Here, the observed bit rate based on UL transmission may be associated with a total data_{capacity}, and based on the observed bit rate, the UE may estimate the maximum network capacity may be calculated as

$$capa {city}_{max} = \frac{\sum {data}_{capacity} in burst duration}{burst duration} .$$

Here, the maximum network capacity calculated using the burst duration 528 may be greater than a maximum network capacity calculated using the UL burst period 524

$$( {capacity}_{max}^{′} = \frac{\sum {data}_{capacity} in burst duration}{UL burst period} ) ,$$

because the UL burst period 524 is greater than the burst duration 528. (UL burst period 524=SR lead time 526+burst duration 528) For example, at 912, the UE 902 may determine an observed bit rate based on UL transmissions of the UE 902. Furthermore, 1012 may be performed by the network throughput estimation component 198.

At 1014, the UE may estimate the UL throughput based on the determined observed bit rate over the burst duration 528. In one example, the UE may determine the capacity(n)=(1−μ)·capacityₘᵢₙ+μ·capacityₘₐₓ, and at window n, and estimate the UL throughput as R_{estf}(n)=min((1−α)·R_{estf}(n−1)+α·capacity(n), configured throughput), where the capacityₘₐₓ is determined based on burst duration 528. Accordingly, the estimated UL throughput of the small burst window may have improved accuracy with reduced error. For example, at 914, the UE 902 may estimate the UL throughput based on the determined observed bit rate over the burst duration 528. Furthermore, 1014 may be performed by the network throughput estimation component 198.

In some aspects, the UE may improve the accuracy of the network throughput estimation for a window with the low burst duration by calculating a scaling factor between the channel bit rate and the estimated network throughput of a time window with a sufficient burst duration and estimate the network throughput of the low burst duration based on the estimated channel bit rate and the scaling factor.

At 1020, the determined burst duration 528 may be a previous burst duration and the estimated UL throughput is a previously estimated UL throughput, and the UE may estimate a current UL throughput based on the previously estimated UL throughput, previous estimated UL channel bit rate, and current estimated UL channel bit rate. For example, at 920, the UE 902 may estimate a current UL throughput based on the previously estimated UL throughput, previous estimated UL channel bit rate, and current estimated UL channel bit rate. Furthermore, 1020 may be performed by the network throughput estimation component 198.

In the low burst duration window, the network throughput estimation may be underestimated or overestimated, and therefore, the UE may reduce the error by using a scaling factor between the calculated channel bit rate and the estimated network throughput at a time window with a sufficient burst duration percentage (e.g., max throughput). Assuming that the scaling factor may represent the offset the between the channel bit rate and the network throughput associated with the current UE/network configurations (e.g., RBs, CC, layers, etc. The UE may use the updated channel condition, UE/network configurations), the UE may use the scaling factor from the sufficient burst duration window to estimate the network throughput based on the low burst duration window.

The current UL throughput may be estimated based on the previously estimated UL throughput, the previous estimated UL channel bit rate, and a current estimated UL channel bit rate when both the current burst duration within the current window is less than or equal to the threshold percentage of the window length and a number of windows between the current window and the previous window is less than a threshold number of windows. Here, the current UL throughput may be associated with a current window (e.g., window (n+k)) which is a slow burst duration window, and the previously estimated UL throughput and the previously estimated UL channel bit rate are associated with a sufficient burst duration window (e.g., window n), and the index number different (e.g., k) may be less than a threshold number. Here, the previous estimated UL channel bit rate and current estimated UL channel bit rate may be one of an estimated UL capacity (e.g., Shannon) or an estimated UL spectral efficiency.

The current UL throughput may be estimated to be R2=R1*c2/c1, where R2 is the estimated current UL throughput, R1 is the previously estimated UL throughput, c2 is the current estimated UL channel bit rate, and c1 is the previous estimated UL channel bit rate, and wherein the current window is associated with the estimated current UL throughput, and the window is a previous window associated with the previously estimated UL throughput, the previous window having a burst duration that exceeds a burst duration threshold.

Here, the channel bit rate c1 of the previous throughput may be (A) calculated based on collected UE measurements (e.g., scheduled throughput which is greater than maximum network capacity), or (B) estimated using a function of layers, a number of the component carriers (CCs), etc. For example, the channel bit rate c1 may be estimated as a function of an RSRP, an RSRQ, an SNR, an SINR, a path loss, MIMO layers, a number of CCs, a scheduling rate, a bandwidth, traffic type, or a PHR. The channel bit rate c2 of the current window may be estimated using a function of layers, a number of the CCs, etc. For example, the channel bit rate c2 may be estimated as a function of an RSRP, an RSRQ, an SNR, an SINR, a path loss, MIMO layers, a number of CCs, a bandwidth, a traffic type, or a PHR.

In one aspect, for the UL transmission, the previous estimated UL channel bit rate and the current estimated UL channel bit rate may be based on at least one of an RSRP, an RSRQ, an SNR, an SINR, a path loss, MIMO layers, a number of CCs, a scheduling rate, a bandwidth, a traffic type, or a PHR. In another aspect, for the UL/DL transmission, the previous estimated channel bit rate and the current estimated channel bit rate may be based on at least one of an RSRP, an RSRQ, an SNR, an SINR, a path loss, MIMO layers, a number of CCs, a scheduling rate, a bandwidth, a traffic type, or a PHR.

The current UL throughput may be estimated based on the previously estimated UL throughput, the previous estimated UL channel bit rate, and the current estimated UL channel bit rate based at least on a current burst duration within a current window being less than or equal to a threshold percentage of a window length of the window and the current window.

In some aspects, the UE may improve the accuracy of the network throughput estimation for a window with the low burst duration by dynamically adjusting the associated parameters by comparing the estimated network throughput with a base throughput.

At 1022, the UE may optimize configurable variables for estimating the current UL throughput based on a difference between the current UL throughput and a base UL throughput. For example, at 922, the UE 902 may optimize configurable variables for estimating the current UL throughput based on a difference between the current UL throughput and a base UL throughput. Furthermore, 1022 may be performed by the network throughput estimation component 198.

The base throughput may refer to an estimated rate (or a network throughput) of a time window with a burst duration percentage greater than or equal to a threshold value, e.g., 80%. In one aspect, the UE may keep a record (or database) of the estimated rates of the time windows with burst duration percentages greater than or equal to the threshold value and the associated parameters, such as channel, UE, network configurations, and the UE may select the estimated rate from the record of the multiple estimated rate that matches the parameters of the current window as the base throughput for reference. Then, the UE may perform an error analysis of the current estimated throughput based on the selected base throughput as the reference value. The UE may determine to perform the optimization if the result of the error analysis of the current estimated throughput is greater than or equal to a threshold value.

The configurable variables may include at least one of a window length of the window (e.g., T₁ 432 and T₂ 434), a window stepsize (e.g., window step 436) for adjusting the window when estimating additional UL throughputs, a linear coefficient (e.g., u) for estimating the UL throughput, a filter coefficient (e.g., a) for estimating the UL throughput based on a previously estimated UL throughput, or a burst duration threshold associated with the window (e.g., burst duration percentage threshold value for determining the low burst duration window, the sufficient burst duration window, or the base throughput).

At 1024, the UE may communicate with a network entity in UL based on the estimated UL throughput. Accordingly, the estimated throughput may not be underestimated or overestimated for the small burst window or a low burst duration window, and the application of the UE 902 may properly optimize its future behavior. For example, at 924, the UE 902 may communicate with a network entity in UL based on the estimated UL throughput. Furthermore, 1024 may be performed by the network throughput estimation component 198.

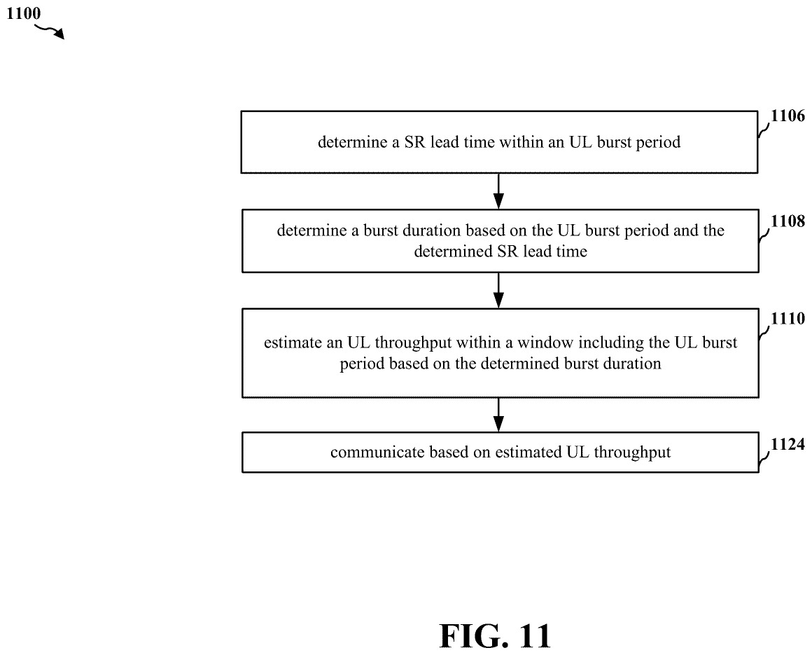

FIG. 11 is a flowchart 1100 of a method of wireless communication. The method may be performed by a UE (e.g., the UE 104; the apparatus 1404). The flowchart 1100 may include a UE and a network node. The UE may be configured to communicate with the network node 804 to receive wireless network access. The UE may perform an enhanced network throughput for a small burst window or a low burst duration window. For the network throughput estimation for an UL transmission with a small burst, the UE may calculate the burst duration 528 by excluding the SR lead time 526 from the burst period 524.

In some aspects, the UE may improve the accuracy of the network throughput estimation with the small burst by calculating the UL burst duration (e.g., burst duration 528) by excluding an SR lead time 526 from the UL burst period (e.g., UL burst period 524).

At 1106, the UE may determine an SR lead time 526 within an UL burst period (e.g., UL burst period 524). Here, the SR lead time (e.g., SR lead time 526/526) may be determined based on a time period between when data is first available in a buffer at the UE for UL transmission where previously there is no data in the buffer before an SR is transmitted and when a first PUSCH based on an UL grant is transmitted subsequent to transmitting the SR and receiving the UL grant based on the transmitted SR, and the UL burst period 524 may be a time period between when data is first available in a buffer at the UE for UL transmission where previously there is no data in the buffer and when the data is completely transmitted from the buffer resulting in no data in the buffer. Because each UL burst period 524 includes the SR lead time 526 that does not include the transmission of the PUSCH bursts, the estimation of the network throughput using the UL burst period 524 may be affected by the SR lead time 526, and the SR lead time 526 may have relatively greater affect for the small burst window with shorter UL burst period. Accordingly, the UE may determine the SR lead time 526 and use the burst duration 528 for network throughput estimation, where the burst duration 528 is determined by excluding the SR lead time 526 from the UL burst period 524. The SR lead time 526 may include dynamic SR lead time determined dynamically for each UL burst period 524, or static SR lead time statically estimated or calculated as an average SR lead time. In one aspect, the burst duration 528 may be determined based on the UL burst period 524 excluding the determined SR lead time 526. Here, the burst duration 528 may be determined to be a maximum of (A) the UL burst period excluding the determined SR lead time 526, and (B) a number of slots per each UL slot. In another aspect, the determined SR lead time 526 may be the average SR lead time, and the burst duration 528 is determined based on the UL burst period 524 excluding the determined average SR lead time. The burst duration 528 may be determined to be a maximum of (A) the UL burst period 524 excluding the determined average SR lead time, and (B) a number of slots per each UL slot, and the average SR lead time may be an average time period that the UE waits to send that SR that depends on an SR periodicity and an average delay for the UE to transmit a first PUSCH as a result of an UL grant that the UE receives after sending the SR. For example, at 906, the UE 902 may determine an SR lead time 526 within an UL burst period (e.g., UL burst period 524). Furthermore, 1106 may be performed by a network throughput estimation component 198.

At 1108, the UE may determine a burst duration (e.g., burst duration 528; burst duration 528) based on the UL burst period 524 and the determined SR lead time 526. That is, the UE may determine the burst duration 528 by excluding the SR lead time 526 determined at 1106 from the UL burst period 524. Here, the SR lead time 526 may be the dynamic SR lead time or the static SR lead time. For example, at 908, the UE 902 may determine a burst duration (e.g., burst duration 528; burst duration 528) based on the UL burst period 524 and the determined SR lead time 526. Furthermore, 1108 may be performed by the network throughput estimation component 198.

At 1110, the UE may estimate an UL throughput within a window including the UL burst period 524 based on the determined burst duration 528. By estimating the network throughput based on the burst duration 528 and not the UL burst period 524, the UE may reduce the effect of the SR lead time 526 in the small burst window, and improve the accuracy of the network throughput estimation. For example, at 910, the UE 902 may estimate an UL throughput within a window including the UL burst period 524 based on the determined burst duration 528. Furthermore, 1110 may be performed by the network throughput estimation component 198.

At 1124, the UE may communicate with a network entity in UL based on the estimated UL throughput. For example, at 924, the UE 902 may communicate with a network entity in UL based on the estimated UL throughput. Furthermore, 1124 may be performed by the network throughput estimation component 198.

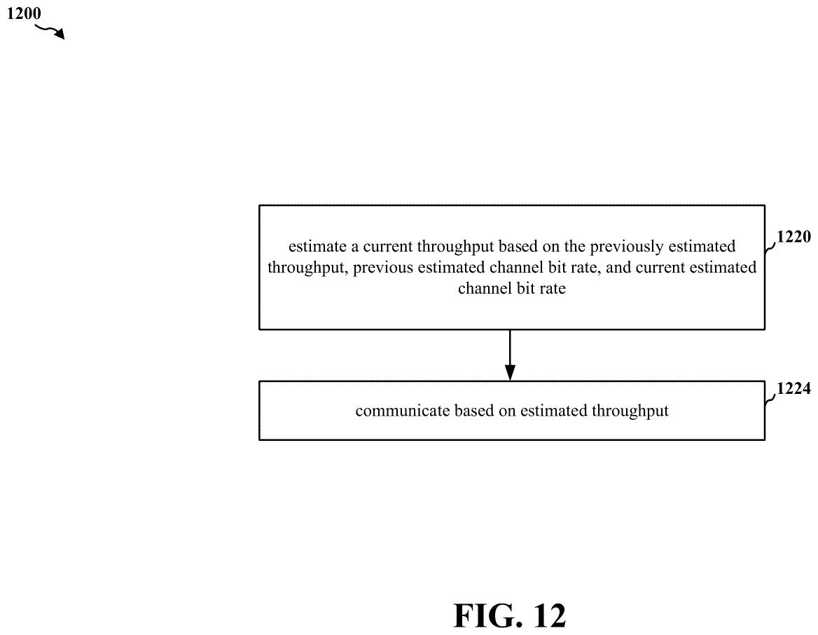

FIG. 12 is a flowchart 1200 of a method of wireless communication. The method may be performed by a UE (e.g., the UE 104; the apparatus 1404). The flowchart 1200 may include a UE and a network node. The UE may be configured to communicate with the network node 804 to receive wireless network access. The UE may perform an enhanced network throughput for a small burst window or a low burst duration window. For the network throughput estimation for a window with the low burst duration, the UE may calculate a scaling factor between the channel bit rate and the estimated network throughput of a time window with a sufficient burst duration and estimate the network throughput of the low burst duration based on the estimated channel bit rate and the scaling factor.

In some aspects, the UE may improve the accuracy of the network throughput estimation for a window with the low burst duration by calculating a scaling factor between the channel bit rate and the estimated network throughput of a time window with a sufficient burst duration and estimate the network throughput of the low burst duration based on the estimated channel bit rate and the scaling factor.

At 1220, the UE may estimate a current UL/DL throughput based on a previously estimated UL/DL throughput, previous estimated UL/DL channel bit rate, and current estimated UL/DL channel bit rate. For example, at 920, the UE 902 may estimate a current UL/DL throughput based on the previously estimated UL/DL throughput, previous estimated UL/DL channel bit rate, and current estimated UL/DL channel bit rate. Furthermore, 1220 may be performed by the network throughput estimation component 198.

In the low burst duration window, the network throughput estimation may be underestimated or overestimated, and therefore, the UE may reduce the error by using a scaling factor between the calculated channel bit rate and the estimated network throughput at a time window with a sufficient burst duration percentage (e.g., max throughput). Assuming that the scaling factor may represent the offset the between the channel bit rate and the network throughput associated with the current UE/network configurations (e.g., RBs, CC, layers, etc. The UE may use the updated channel condition, UE/network configurations), the UE may use the scaling factor from the sufficient burst duration window to estimate the network throughput based on the low burst duration window.

The current network throughput may be estimated based on the previously estimated network throughput, the previous estimated UL/DL channel bit rate, and a current estimated UL/DL channel bit rate when both the current burst duration within the current window is less than or equal to the threshold percentage of the window length and a number of windows between the current window and the previous window is less than a threshold number of windows. Here, the current network throughput may be associated with a current window (e.g., window (n+k)) which is a slow burst duration window, and the previously estimated network throughput and the previously estimated UL/DL channel bit rate are associated with a sufficient burst duration window (e.g., window n), and the index number different (e.g., k) may be less than a threshold number. Here, the previous estimated UL/DL channel bit rate and current estimated UL/DL channel bit rate may be one of an estimated UL/DL capacity (e.g., Shannon) or an estimated network spectral efficiency.

The current network throughput may be estimated to be R2=R1*c2/c1, where R2 is the estimated current network throughput, R1 is the previously estimated network throughput, c2 is the current estimated UL/DL channel bit rate, and c1 is the previous estimated UL/DL channel bit rate, and wherein the current window is associated with the estimated current network throughput, and the window is a previous window associated with the previously estimated network throughput, the previous window having a burst duration that exceeds a burst duration threshold.

Here, the c1 of the previous window may be (A) calculated based on collected UE measurements (e.g., scheduled throughput which is greater than maximum network capacity), or (B) estimated using a function of layers, a number of the component carriers (CCs), etc. For example, the channel bit rate c1 may be estimated as a function of an RSRP, an RSRQ, an SNR, an SINR, a path loss, MIMO layers, a number of CCs, a scheduling rate, a bandwidth, a traffic type, or a PHR. The c2 of the current window may be estimated using a function of layers, a number of the CCs, etc. For example, the channel bit rate c2 may be estimated as a function of an RSRP, an RSRQ, an SNR, an SINR, a path loss, MIMO layers, a number of CCs, a bandwidth, a traffic type, or a PHR.

The previous estimated channel bit rate and the current estimated channel bit rate may be based on at least one of an RSRP, an RSRQ, an SNR, an SINR, a path loss, MIMO layers, a number of CCs, a scheduling rate, a bandwidth, a traffic type, or a PHR.

The current network throughput may be estimated based on the previously estimated network throughput, the previous estimated UL/DL channel bit rate, and the current estimated UL/DL channel bit rate based at least on a current burst duration within a current window being less than or equal to a threshold percentage of a window length of the window and the current window.

At 1224, the UE may communicate with a network entity in UL/DL based on the estimated network throughput. Accordingly, the estimated throughput may not be underestimated or overestimated for the small burst window or a low burst duration window, and the application of the UE 902 may properly optimize its future behavior. For example, at 924, the UE 902 may communicate with a network entity in UL/DL based on the estimated network throughput. Furthermore, 1224 may be performed by the network throughput estimation component 198.

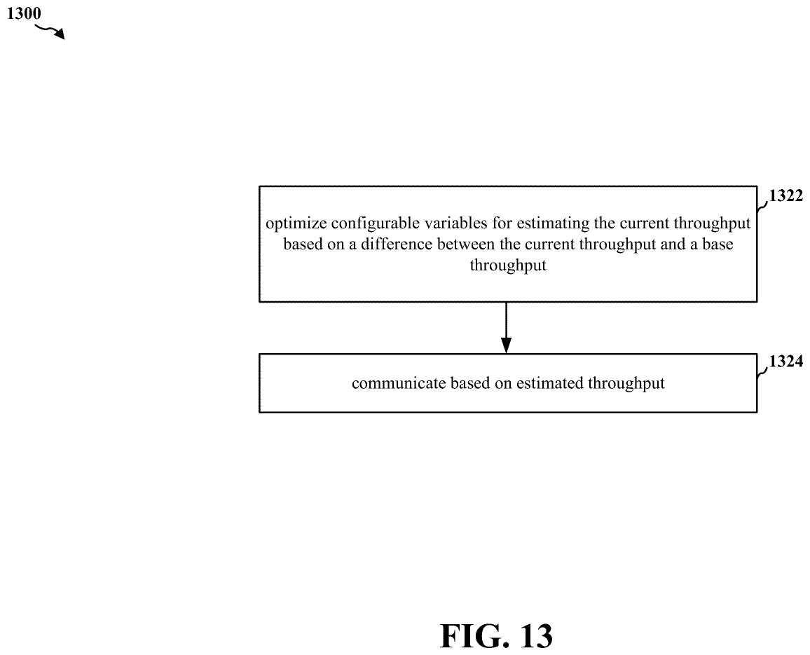

FIG. 13 is a flowchart 1300 of a method of wireless communication. The method may be performed by a UE (e.g., the UE 104; the apparatus 1404). The flowchart 1300 may include a UE and a network node. The UE may be configured to communicate with the network node 804 to receive wireless network access. The UE may perform an enhanced network throughput for a small burst window or a low burst duration window. To improve the overall process of the network throughput estimation, the UE may dynamically adjust the associated parameters by comparing the estimated network throughput with a base throughput.

In some aspects, the UE may improve the accuracy of the network throughput estimation for a window with the low burst duration by dynamically adjusting the associated parameters by comparing the estimated network throughput with a base throughput.

At 1322, the UE may optimize configurable variables for estimating the current Network throughput based on a difference between the current Network throughput and a base Network throughput. For example, at 922, the UE 902 may optimize configurable variables for estimating the current Network throughput based on a difference between the current Network throughput and a base Network throughput. Furthermore, 1322 may be performed by the network throughput estimation component 198.

The base throughput may refer to an estimated rate (or a network throughput) of a time window with a burst duration percentage greater than or equal to a threshold value, e.g., 80%. In one aspect, the UE may keep a record (or database, circular buffer, etc.) of the estimated rates of the time windows with burst duration percentages greater than or equal to the threshold value and the associated parameters, such as channel, UE, network configurations, and the UE may select the estimated rate from the record of the multiple estimated rate that matches the parameters of the current window as the base throughput for reference. Then, the UE may perform an error analysis of the current estimated throughput based on the selected base throughput as the reference value. The UE may determine to perform the optimization if the result of the error analysis of the current estimated throughput is greater than or equal to a threshold value.

The configurable variables may include at least one of a window length of the window (e.g., T₁ 432 and T₂ 434), a window stepsize (e.g., window step 436) for adjusting the window when estimating additional Network throughputs, a linear coefficient (e.g., u) for estimating the Network throughput, a filter coefficient (e.g., a) for estimating the Network throughput based on a previously estimated Network throughput, or a burst duration threshold associated with the window (e.g., burst duration percentage threshold value for determining the low burst duration window, the sufficient burst duration window, or the base throughput).

At 1324, the UE may communicate with a network entity in UL/DL based on the estimated UL/DL throughput. For example, at 924, the UE 902 may communicate with a network entity in UL/DL based on the estimated network throughput. Furthermore, 1324 may be performed by the network throughput estimation component 198.

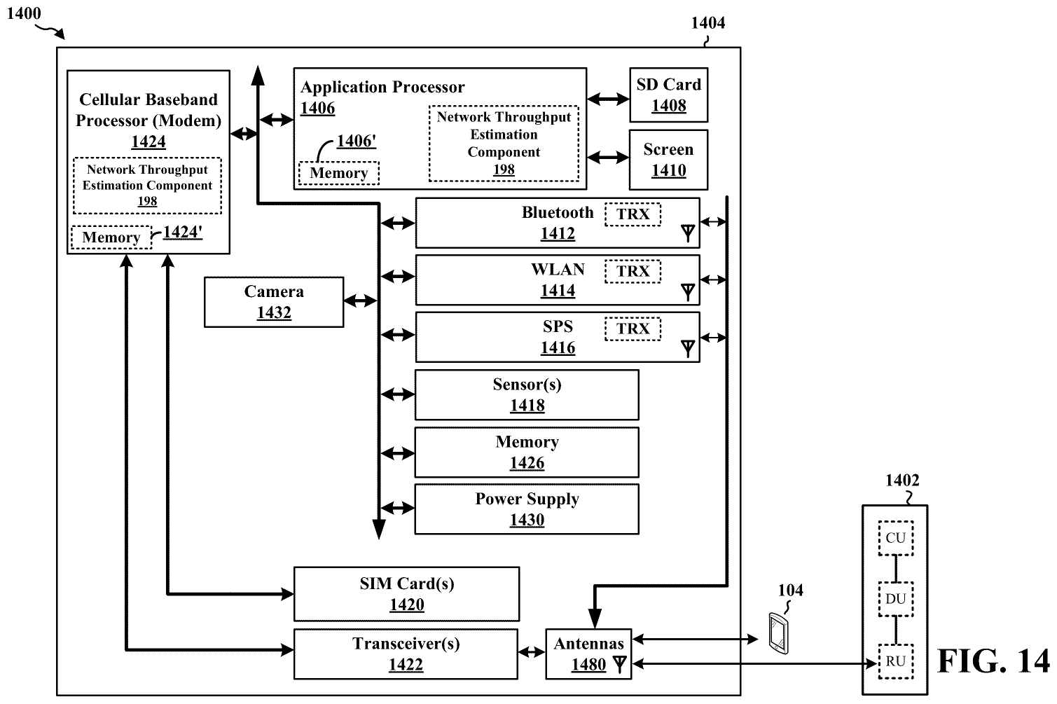

FIG. 14 is a diagram 1400 illustrating an example of a hardware implementation for an apparatus 1404. The apparatus 1404 may be a UE, a component of a UE, or may implement UE functionality. In some aspects, the apparatus 1404 may include a cellular baseband processor 1424 (also referred to as a modem) coupled to one or more transceivers 1422 (e.g., cellular RF transceiver). The cellular baseband processor 1424 may include on-chip memory 1424′. In some aspects, the apparatus 1404 may further include one or more subscriber identity modules (SIM) cards 1420 and an application processor 1406 coupled to a secure digital (SD) card 1408 and a screen 1410. The application processor 1406 may include on-chip memory 1406′. In some aspects, the apparatus 1404 may further include a Bluetooth module 1412, a WLAN module 1414, an SPS module 1416 (e.g., GNSS module), one or more sensor modules 1418 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1426, a power supply 1430, and/or a camera 1432. The Bluetooth module 1412, the WLAN module 1414, and the SPS module 1416 may include an on-chip transceiver (TRX) (or in some cases, just a receiver (RX)). The Bluetooth module 1412, the WLAN module 1414, and the SPS module 1416 may include their own dedicated antennas and/or utilize the antennas 1480 for communication. The cellular baseband processor 1424 communicates through the transceiver(s) 1422 via one or more antennas 1480 with the UE 104 and/or with an RU associated with a network entity 1402. The cellular baseband processor 1424 and the application processor 1406 may each include a computer-readable medium/memory 1424′, 1406′, respectively. The additional memory modules 1426 may also be considered a computer-readable medium/memory. Each computer-readable medium/memory 1424′, 1406′, 1426 may be non-transitory. The cellular baseband processor 1424 and the application processor 1406 are each responsible for general processing, including the execution of software stored on the computer-readable medium/memory. The software, when executed by the cellular baseband processor 1424/application processor 1406, causes the cellular baseband processor 1424/application processor 1406 to perform the various functions described supra. The computer-readable medium/memory may also be used for storing data that is manipulated by the cellular baseband processor 1424/application processor 1406 when executing software. The cellular baseband processor 1424/application processor 1406 may be a component of the UE 350 and may include the memory 360 and/or at least one of the TX processor 368, the RX processor 356, and the controller/processor 359. In one configuration, the apparatus 1404 may be a processor chip (modem and/or application) and include just the cellular baseband processor 1424 and/or the application processor 1406, and in another configuration, the apparatus 1404 may be the entire UE (e.g., see 350 of FIG. 3) and include the additional modules of the apparatus 1404.

As discussed supra, the network throughput estimation component 198 is configured to determine a SR lead time within an UL burst period, determine a burst duration based on the UL burst period and the determined SR lead time, and estimate an UL throughput within a window including the UL burst period based on the determined burst duration. The network throughput estimation component 198 is also configured to estimate a previous throughput, and estimate a current throughput in a window based on the previously estimated throughput, a previous estimated channel bit rate, and a current estimated channel bit rate. The network throughput estimation component 198 is also configured to optimize configurable variables for estimating the current throughput based on a difference between the current throughput and a base throughput, and estimate a current throughput in a window based on the previously estimated throughput, a previous estimated channel bit rate, and a current estimated channel bit rate. The network throughput estimation component 198 may be within the cellular baseband processor 1424, the application processor 1406, or both the cellular baseband processor 1424 and the application processor 1406. The network throughput estimation component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1404 may include a variety of components configured for various functions. In one configuration, the apparatus 1404, and in particular the cellular baseband processor 1424 and/or the application processor 1406, may include means for determining a SR lead time within an UL burst period, means for determining a burst duration based on the UL burst period and the determined SR lead time, and means for estimating an UL throughput within a window including the UL burst period based on the determined burst duration. In one configuration, the apparatus 1404, and in particular the cellular baseband processor 1424 and/or the application processor 1406, may include means for communicating with a network entity in UL based on the estimated UL throughput. In one configuration, the means for estimating the UL throughput based on the burst duration may is configured to determine an observed bit rate based on UL transmissions of the UE, and to estimate the UL throughput based on the determined observed bit rate over the burst duration. In one configuration, the UL burst period is a time period between when data is first available in a buffer at the UE for UL transmission where previously there is no data in the buffer and when the data is completely transmitted from the buffer resulting in no data in the buffer. In one configuration, the SR lead time is determined based on a time period between when data is first available in a buffer at the UE for UL transmission where previously there is no data in the buffer before the SR is transmitted and when a first PUSCH based on an UL grant is transmitted subsequent to transmitting the SR and receiving the UL grant based on the transmitted SR. In one configuration, the burst duration is determined based on the UL burst period excluding the determined SR lead time. In one configuration, the burst duration is determined to be a maximum of (A) the UL burst period excluding the determined SR lead time, and (B) a number of slots per each UL slot. In one configuration, the determined SR lead time is an average SR lead time, and the burst duration is determined based on the UL burst period excluding the determined average SR lead time. In one configuration, the burst duration is determined to be a maximum of (A) the UL burst period excluding the determined average SR lead time, and (B) a number of slots per each UL slot. In one configuration, the average SR lead time is an average time period that the UE waits to send the SR that depends on an SR periodicity and an average delay for the UE to transmit a first PUSCH as a result of the UL grant that the UE receives after sending the SR. In one configuration, the determined burst duration is a previous burst duration and the estimated UL throughput is a previously estimated UL throughput, and the apparatus 1404, and in particular the cellular baseband processor 1424 and/or the application processor 1406, may include means for estimating a current UL throughput based on the previously estimated UL throughput, previous estimated UL channel bit rate, and current estimated UL channel bit rate. In one configuration, the previous estimated UL channel bit rate and the current estimated UL channel bit rate are based on at least one of an RSRP, an RSRQ, an SNR, an SINR, a path loss, MIMO layers, a number of CCs, a scheduling rate, a bandwidth, a traffic type, or a PHR. In one configuration, the current UL throughput is estimated based on the previously estimated UL throughput, the previous estimated UL channel bit rate, and the current estimated UL channel bit rate based at least on a current burst duration within a current window being less than or equal to a threshold percentage of a window length of the window and the current window. In one configuration, the current UL throughput is estimated to be R2=R1*c2/c1, where R2 is the estimated current UL throughput, R1 is the previously estimated UL throughput, c2 is the current estimated UL channel bit rate, and c1 is the previous estimated UL channel bit rate, and where the current window is associated with the estimated current UL throughput, and the window is a previous window associated with the previously estimated UL throughput, the previous window having the burst duration that exceeds a burst duration threshold. In one configuration, the current UL throughput is estimated based on the previously estimated UL throughput, the previous estimated UL channel bit rate, and the current estimated UL channel bit rate when both the current burst duration within the current window is less than or equal to the threshold percentage of the window length and a number of windows between the current window and the previous window is less than a threshold number of windows. In one configuration, the apparatus 1404, and in particular the cellular baseband processor 1424 and/or the application processor 1406, may include means for optimizing configurable variables for estimating the current UL throughput based on a difference between the current UL throughput and a base UL throughput. In one configuration, the configurable variables include at least one of a window length of the window, a window stepsize for adjusting the window when estimating additional UL throughputs, a linear coefficient for estimating the UL throughput, a filter coefficient for estimating the UL throughput based on the previously estimated UL throughput, or a burst duration threshold associated with the window. In one configuration, the previous estimated UL channel bit rate and the current estimated UL channel bit rate are one of an estimated UL capacity or an estimated UL spectral efficiency. In one configuration, the apparatus 1404, and in particular the cellular baseband processor 1424 and/or the application processor 1406, may include means for estimating a previous throughput, and means for estimating a current throughput in a window based on the previously estimated throughput, a previous estimated channel bit rate, and a current estimated channel bit rate. In one configuration, the previous estimated channel bit rate and the current estimated channel bit rate may be based on at least one of an RSRP, an RSRQ, an SNR, an SINR, a path loss, MIMO layers, a number of CCs, a scheduling rate, a bandwidth, a traffic type, or a PHR. In one configuration, the current throughput may be estimated based on the previously estimated throughput, the previous estimated channel bit rate, and the current estimated channel bit rate based at least on a current burst duration within a current window being less than or equal to a threshold percentage of a window length of the window and the current window. In one configuration, the current throughput may be estimated to be R2=R1*c2/c1, where R2 is the estimated current throughput, R1 is the previously estimated throughput, c2 is the current estimated channel bit rate, and c1 is the previous estimated channel bit rate, and where the current window is associated with the estimated current throughput, and the window is a previous window associated with the previously estimated throughput, the previous window having a burst duration that exceeds a burst duration threshold. In one configuration, the apparatus 1404, and in particular the cellular baseband processor 1424 and/or the application processor 1406, may include means for optimizing configurable variables for estimating the current throughput based on a difference between the current throughput and a base throughput, and means for estimating a current throughput in a window based on the previously estimated throughput, a previous estimated channel bit rate, and a current estimated channel bit rate. In one configuration, the configurable variables may include at least one of a window length of the window, a window stepsize for adjusting the window when estimating additional throughputs, a linear coefficient for estimating the throughput, a filter coefficient for estimating the throughput based on a previously estimated throughput, or a burst duration threshold associated with the window. The means may be the network throughput estimation component 198 of the apparatus 1404 configured to perform the functions recited by the means. As described supra, the apparatus 1404 may include the TX processor 368, the RX processor 356, and the controller/processor 359. As such, in one configuration, the means may be the TX processor 368, the RX processor 356, and/or the controller/processor 359 configured to perform the functions recited by the means.

A UE may be configured to determine an SR lead time within an UL burst period, determine a burst duration based on the UL burst period and the determined SR lead time, and estimate an UL throughput within a window including the UL burst period based on the determined burst duration. The UE may estimate a previous throughput, and estimate a current throughput in a window based on the previously estimated throughput, a previous estimated channel bit rate, and a current estimated channel bit rate. The UE may optimize configurable variables for estimating the current throughput based on a difference between the current throughput and a base throughput, and estimate a current throughput in a window based on the previously estimated throughput, a previous estimated channel bit rate, and a current estimated channel bit rate.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, including determining a SR lead time within an UL burst period, determining a burst duration based on the UL burst period and the determined SR lead time, and estimating an UL throughput within a window including the UL burst period based on the determined burst duration.

Aspect 2 is the method of aspect 1, further including transmitting with a network entity in UL based on the estimated UL throughput.

Aspect 3 is the method of any of aspects 1 and 2, where the estimating the UL throughput based on the burst duration includes determining an observed bit rate based on UL transmissions of the UE, and estimating the UL throughput based on the determined observed bit rate over the burst duration.

Aspect 4 is the method of any of aspects 1 to 3, where the UL burst period is a time period between when data is first available in a buffer at the UE for UL transmission where previously there is no data in the buffer and when the data is completely transmitted from the buffer resulting in no data in the buffer.

Aspect 5 is the method of any of aspects 1 to 4, where the SR lead time is determined based on a time period between when data is first available in a buffer at the UE for UL transmission where previously there is no data in the buffer before an SR is transmitted and when a first PUSCH based on an UL grant is transmitted subsequent to transmitting the SR and receiving the UL grant based on the transmitted SR.

Aspect 6 is the method of aspect 5, where the burst duration is determined based on the UL burst period excluding the determined SR lead time.

Aspect 7 is the method of aspect 6, where the burst duration is determined to be a maximum of (A) the UL burst period excluding the determined SR lead time, and (B) a number of slots per each UL slot.

Aspect 8 is the method of any of aspects 5 to 7, where the determined SR lead time is an average SR lead time, and the burst duration is determined based on the UL burst period excluding the determined average SR lead time.

Aspect 9 is the method of aspect 8, where the burst duration is determined to be a maximum of (A) the UL burst period excluding the determined average SR lead time, and (B) a number of slots per each UL slot.

Aspect 10 is the method of any of aspects 8 and 9, where the average SR lead time is an average time period that the UE waits to send that SR that depends on an SR periodicity and an average delay for the UE to transmit a first PUSCH as a result of an UL grant that the UE receives after sending the SR.

Aspect 11 is the method of any of aspects 1 to 10, where the determined burst duration is a previous burst duration and the estimated UL throughput is a previously estimated UL throughput, the method further including estimating a current UL throughput based on the previously estimated UL throughput, previous estimated UL channel bit rate, and current estimated UL channel bit rate.

Aspect 12 is the method of aspect 11, where the previous estimated UL channel bit rate and the current estimated UL channel bit rate are based on at least one of an RSRP, an RSRQ, an SNR, an SINR, a path loss, MIMO layers, a number of CCs, a scheduling rate, a bandwidth, a traffic type, or a PHR.

Aspect 13 is the method of any of aspects 11 and 12, where the current UL throughput is estimated based on the previously estimated UL throughput, the previous estimated UL channel bit rate, and the current estimated UL channel bit rate based at least on a current burst duration within a current window being less than or equal to a threshold percentage of a window length of the window and the current window.

Aspect 14 is the method of aspect 13, where the current UL throughput is estimated to be R2=R1*c2/c1, where R2 is the estimated current UL throughput, R1 is the previously estimated UL throughput, c2 is the current estimated UL channel bit rate, and c1 is the previous estimated UL channel bit rate, and where the current window is associated with the estimated current UL throughput, and the window is a previous window associated with the previously estimated UL throughput, the previous window having a burst duration that exceeds a burst duration threshold.

Aspect 15 is the method of any of aspects 13 and 14, where the current UL throughput is estimated based on the previously estimated UL throughput, the previous estimated UL channel bit rate, and the current estimated UL channel bit rate when both the current burst duration within the current window is less than or equal to the threshold percentage of the window length and a number of windows between the current window and the previous window is less than a threshold number of windows.

Aspect 16 is the method of any of aspects 11 to 15, further including optimizing configurable variables for estimating the current UL throughput based on a difference between the current UL throughput and a base UL throughput.

Aspect 17 is the method of aspects 16, where the configurable variables include at least one of a window length of the window, a window stepsize for adjusting the window when estimating additional UL throughputs, a linear coefficient for estimating the UL throughput, a filter coefficient for estimating the UL throughput based on a previously estimated UL throughput, or a burst duration threshold associated with the window.

Aspect 18 is the method of any of aspects 11 to 17, where the previous estimated UL channel bit rate and current estimated UL channel bit rate are one of an estimated UL capacity or an estimated UL spectral efficiency.

Aspect 19 is an apparatus for wireless communication including at least one processor coupled to a memory and configured to implement any of aspects 1 to 18, further including a transceiver coupled to the at least one processor.

Aspect 20 is an apparatus for wireless communication including means for implementing any of aspects 1 to 18.

Aspect 21 is a non-transitory computer-readable medium storing computer executable code, where the code when executed by a processor causes the processor to implement any of aspects 1 to 18.

Aspect 22 is a method of wireless communication at a UE, including estimating a previous throughput, and estimating a current throughput in a window based on the previously estimated throughput, a previous estimated channel bit rate, and a current estimated channel bit rate.

Aspect 23 is the method of aspect 22, where the previous estimated channel bit rate and the current estimated channel bit rate are based on at least one of an RSRP, an RSRQ, an SNR, an SINR, a path loss, MIMO layers, a number of CCs, a scheduling rate, a bandwidth, a traffic type, or a PHR.

Aspect 24 is the method of any of aspects 22 and 23, where the current throughput is estimated based on the previously estimated throughput, the previous estimated channel bit rate, and the current estimated channel bit rate based at least on a current burst duration within a current window being less than or equal to a threshold percentage of a window length of the window and the current window.

Aspect 25 is the method of aspect 24, where the current throughput is estimated to be R2=R1*c2/c1, where R2 is the estimated current throughput, R1 is the previously estimated throughput, c2 is the current estimated channel bit rate, and c1 is the previous estimated channel bit rate, and where the current window is associated with the estimated current throughput, and the window is a previous window associated with the previously estimated throughput, the previous window having a burst duration that exceeds a burst duration threshold.

Aspect 26 is an apparatus for wireless communication including at least one processor coupled to a memory and configured to implement any of aspects 22 to 25, further including a transceiver coupled to the at least one processor.

Aspect 27 is an apparatus for wireless communication including means for implementing any of aspects 22 to 25.

Aspect 28 is a non-transitory computer-readable medium storing computer executable code, where the code when executed by a processor causes the processor to implement any of aspects 22 to 25.

Aspect 29 is a method of wireless communication at a UE, including optimizing configurable variables for estimating the current throughput based on a difference between the current throughput and a base throughput, and estimating a current throughput in a window based on the previously estimated throughput, a previous estimated channel bit rate, and a current estimated channel bit rate.

Aspect 30 is the method of aspect 29, where the configurable variables include at least one of a window length of the window, a window stepsize for adjusting the window when estimating additional throughputs, a linear coefficient for estimating the throughput, a filter coefficient for estimating the throughput based on a previously estimated throughput, or a burst duration threshold associated with the window.

Aspect 31 is an apparatus for wireless communication including at least one processor coupled to a memory and configured to implement any of aspects 29 and 30, further including a transceiver coupled to the at least one processor.

Aspect 32 is an apparatus for wireless communication including means for implementing any of aspects 29 and 30.

Aspect 33 is a non-transitory computer-readable medium storing computer executable code, where the code when executed by a processor causes the processor to implement any of aspects 29 and 30.

What is claimed is:

1. An apparatus for wireless communication at a user equipment (UE), comprising:
a memory; and
at least one processor coupled to the memory and, based at least in part on information stored in the memory, the at least one processor is configured to:
determine a scheduling request (SR) lead time within an uplink (UL) burst period;
determine a burst duration based on the UL burst period and the determined SR lead time; and
estimate an UL throughput within a window including the UL burst period based on the determined burst duration.

2. The apparatus of claim 1, further comprising a transceiver coupled to the at least one processor, wherein the at least one processor is further configured to communicate, using the transceiver, with a network entity in UL based on the estimated UL throughput.

3. The apparatus of claim 1, wherein, to estimate the UL throughput based on the burst duration, the at least one processor is configured to:
determine an observed bit rate based on UL transmissions of the UE; and
estimate the UL throughput based on the determined observed bit rate over the burst duration.

4. The apparatus of claim 1, wherein the UL burst period is a time period between when data is first available in a buffer at the UE for UL transmission where previously there is no data in the buffer and when the data is completely transmitted from the buffer resulting in no data in the buffer.

5. The apparatus of claim 1, wherein the SR lead time is determined based on a time period between when data is first available in a buffer at the UE for UL transmission where previously there is no data in the buffer before the SR is transmitted and when a first physical UL shared channel (PUSCH) based on an UL grant is transmitted subsequent to transmitting the SR and receiving the UL grant based on the transmitted SR.

6. The apparatus of claim 5, wherein the burst duration is determined based on the UL burst period excluding the determined SR lead time.

7. The apparatus of claim 6, wherein the burst duration is determined to be a maximum of (A) the UL burst period excluding the determined SR lead time, and (B) a number of slots per each UL slot.

8. The apparatus of claim 5, wherein the determined SR lead time is an average SR lead time, and the burst duration is determined based on the UL burst period excluding the determined average SR lead time.

9. The apparatus of claim 8, wherein the burst duration is determined to be a maximum of (A) the UL burst period excluding the determined average SR lead time, and (B) a number of slots per each UL slot.

10. The apparatus of claim 8, wherein the average SR lead time is an average time period that the UE waits to send the SR that depends on an SR periodicity and an average delay for the UE to transmit a first PUSCH as a result of the UL grant that the UE receives after sending the SR.

11. The apparatus of claim 1, wherein the determined burst duration is a previous burst duration and the estimated UL throughput is a previously estimated UL throughput,
wherein the at least one processor is further configured to estimate a current UL throughput based on the previously estimated UL throughput, previous estimated UL channel bit rate, and current estimated UL channel bit rate.

12. The apparatus of claim 11, wherein the previous estimated UL channel bit rate and the current estimated UL channel bit rate are based on at least one of a reference signal received power (RSRP), a reference signal received quality (RSRQ), a signal to noise ratio (SNR), a signal to interference plus noise ratio (SINR), a path loss, multiple-input and multiple-output (MIMO) layers, number of component carriers (CCs), a scheduling rate, a bandwidth, a traffic type, or a power headroom report.

13. The apparatus of claim 11, wherein the current UL throughput is estimated based on the previously estimated UL throughput, the previous estimated UL channel bit rate, and the current estimated UL channel bit rate based at least on a current burst duration within a current window being less than or equal to a threshold percentage of a window length of the window and the current window.

14. The apparatus of claim 13, wherein the current UL throughput is estimated to be R2=R1*c2/c1, where R2 is the estimated current UL throughput, R1 is the previously estimated UL throughput, c2 is the current estimated UL channel bit rate, and c1 is the previous estimated UL channel bit rate, and wherein the current window is associated with the estimated current UL throughput, and the window is a previous window associated with the previously estimated UL throughput, the previous window having the burst duration that exceeds a burst duration threshold.

15. The apparatus of claim 13, wherein the current UL throughput is estimated based on the previously estimated UL throughput, the previous estimated UL channel bit rate, and the current estimated UL channel bit rate when both the current burst duration within the current window is less than or equal to the threshold percentage of the window length and a number of windows between the current window and a previous window is less than a threshold number of windows.

16. The apparatus of claim 11, wherein the at least one processor is further configured to optimize configurable variables for estimating the current UL throughput based on a difference between the current UL throughput and a base UL throughput.

17. The apparatus of claim 16, wherein the configurable variables include at least one of a window length of the window, a window stepsize for adjusting the window when estimating additional UL throughputs, a linear coefficient for estimating the UL throughput, a filter coefficient for estimating the UL throughput based on the previously estimated UL throughput, or a burst duration threshold associated with the window.

18. The apparatus of claim 11, wherein the previous estimated UL channel bit rate and the current estimated UL channel bit rate are one of an estimated UL capacity or an estimated UL spectral efficiency.

19. A method of wireless communication at a user equipment (UE), comprising:
determining a scheduling request (SR) lead time within an uplink (UL) burst period;
determining a burst duration based on the UL burst period and the determined SR lead time; and
estimating an UL throughput within a window including the UL burst period based on the determined burst duration.

20. The method of claim 19, further comprising:
transmitting with a network entity in UL based on the estimated UL throughput.

21. The method of claim 19, wherein the estimating the UL throughput based on the burst duration comprises:
determining an observed bit rate based on UL transmissions of the UE; and
estimating the UL throughput based on the determined observed bit rate over the burst duration.

22. The method of claim 19, wherein the SR lead time is determined based on a time period between when data is first available in a buffer at the UE for UL transmission where previously there is no data in the buffer before the SR is transmitted and when a first physical UL shared channel (PUSCH) based on an UL grant is transmitted subsequent to transmitting the SR and receiving the UL grant based on the transmitted SR,
wherein the burst duration is determined based on the UL burst period excluding the determined SR lead time.

23. The method of claim 19, wherein the determined SR lead time is an average SR lead time, and the burst duration is determined based on the UL burst period excluding the determined average SR lead time,
wherein the average SR lead time is an average time period that the UE waits to send the SR that depends on an SR periodicity and an average delay for the UE to transmit a first PUSCH as a result of an UL grant that the UE receives after sending the SR.

24. The method of claim 19, wherein the determined burst duration is a previous burst duration and the estimated UL throughput is a previously estimated UL throughput, the method further comprising:
estimating a current UL throughput based on the previously estimated UL throughput, previous estimated UL channel bit rate, and current estimated UL channel bit rate.

25. The method of claim 24, wherein the current UL throughput is estimated based on the previously estimated UL throughput, the previous estimated UL channel bit rate, and the current estimated UL channel bit rate based at least on a current burst duration within a current window being less than or equal to a threshold percentage of a window length of the window and the current window.

26. The method of claim 25, wherein the current UL throughput is estimated to be R2=R1*c2/c1, where R2 is the estimated current UL throughput, R1 is the previously estimated UL throughput, c2 is the current estimated UL channel bit rate, and c1 is the previous estimated UL channel bit rate, and wherein the current window is associated with the estimated current UL throughput, and the window is a previous window associated with the previously estimated UL throughput, the previous window having the burst duration that exceeds a burst duration threshold.

27. The method of claim 25, wherein the current UL throughput is estimated based on the previously estimated UL throughput, the previous estimated UL channel bit rate, and the current estimated UL channel bit rate when both the current burst duration within the current window is less than or equal to the threshold percentage of the window length and a number of windows between the current window and a previous window is less than a threshold number of windows.

28. The method of claim 24, further comprising optimizing configurable variables for estimating the current UL throughput based on a difference between the current UL throughput and a base UL throughput.

29. An apparatus for wireless communication at a user equipment (UE), comprising:
means for determining a scheduling request (SR) lead time within an uplink (UL) burst period;
means for determining a burst duration based on the UL burst period and the determined SR lead time; and
means for estimating an UL throughput within a window including the UL burst period based on the determined burst duration.

30. A computer-readable medium storing computer executable code at a user equipment (UE), the code when executed by a processor causes the processor to:
determine a scheduling request (SR) lead time within an uplink (UL) burst period;
determine a burst duration based on the UL burst period and the determined SR lead time; and
estimate an UL throughput within a window including the UL burst period based on the determined burst duration.
